(19) United States
(12) Patent Application Publication
(10) Pub. No.: US 2025/0193089 A1
(43) Pub. Date: Jun. 12, 2025

(54) METHOD AND APPARATUS FOR SELECTING BEAM IN WIRELESS COMMUNICATION SYSTEM

(71) Applicant: ELECTRONICS AND TELECOMMUNICATIONS RESEARCH INSTITUTE, Daejeon (KR)

(72) Inventor: Minhyun KIM, Daejeon (KR)

(73) Assignee: ELECTRONICS AND TELECOMMUNICATIONS RESEARCH INSTITUTE, Daejeon (KR)

(21) Appl. No.: 18/971,883

(22) Filed: Dec. 6, 2024

(30) Foreign Application Priority Data
Dec. 6, 2023 (KR) 10-2023-0175990

(51) Int. Cl. H04L 41/16; H04B 7/06; H04W 24/02

(52) U.S. Cl. CPC H04L 41/16; H04B 7/0626; H04W 24/02

(57) ABSTRACT

The present disclosure relates to a beam selection method and apparatus in a wireless communication system. A method of an SMO according to an exemplary embodiment of the present disclosure may comprise transmitting, to an E2 node, a data collection request message for training an AI/ML model; receiving, from the E2 node, first data collected for training the AI/ML model; and providing the collected first data to a non-real time RIC to train the AI/ML model, wherein the AI/ML model is an AI/ML model for Grid-of-Beams (GoB) beamforming or an AI/ML model for beam selection.

### CROSS-REFERENCE TO RELATED APPLICATIONS

This application claims priority to Korean Patent Application No. 10-2023-0175990, filed on Dec. 6, 2023, with the Korean Intellectual Property Office (KIPO), the entire contents of which are hereby incorporated by reference.

### BACKGROUND

### 1. Technical Field

The present disclosure relates to a beam selection technique in a wireless communication system, and more particularly, to a beam selection technique in an open radio access network (RAN) system.

### 2. Related Art

As mobile services such as social networking, video streaming, and online gaming continue to evolve, post-LTE evolved mobile communication networks are required to satisfy not only high transmission speed demands but also technical requirements to support a wider variety of service scenarios. The International Telecommunication Union Radiocommunication sector (ITU-R) has defined key performance indicators (KPIs) and requirements for IMT-2020, the official name for 5G mobile communications. The KPIs for IMT-2020 are summarized as enhanced Mobile Broadband (eMBB), which ensures high transmission speeds; Ultra-Reliable Low Latency Communication (URLLC), which provides low transmission latency; and massive Machine Type Communication (mMTC), which enables large-scale device connectivity.

The 3rd Generation Partnership Project (3GPP), the international standardization organization for mobile communications, has been developing 5G standard specifications based on a new radio access technology to meet the IMT-2020 requirements. In 5G, significant changes are taking place, such as introduction of Software Defined Networking (SDN) and Network Function Virtualization (NFV) into a core network to enable automation and intelligence in network control, operation, and management. However, a radio access network (RAN), which includes a base station, still operates in a closed structure, being dependent on protocols and interfaces of specific equipment manufacturers. Such dependency results in interoperability issues between equipment from different manufacturers and restricts market entry for various vendors.

In February 2018, five global telecom operators (i.e. AT&T, China Mobile, Deutsche Telekom, NTT DOCOMO, and Orange) have established an Open Radio Access Network (O-RAN) alliance. The O-RAN alliance aims to transform the conventional RAN into a more intelligent, open, virtualized, and fully interoperable mobile communication network. Currently, the O-RAN alliance comprise over 300 members, including telecom operators, enterprises, and research institutions, and is engaged in standardization efforts and open-source platform development to facilitate the advancement of open and intelligent RAN in the 5G era and beyond into 6G.

With the introduction of beamforming in 5G New Radio (NR), unlike in conventional mobile communication systems, the performance of mobile communication systems is now heavily influenced by beamforming methods. The communication performance associated with beamforming is primarily dependent on design of beamforming patterns. Traditionally, beams have been configured in a passive and semi-static manner based on empirical knowledge of mobile communication experts and results of manual testing. Due to such approaches, it has been difficult to proactively adapt to near-real time changes in situational information, leading to severe inter-cell interference and consequently poor performance at cell edges, as well as traffic imbalance between adjacent cells, which negatively impacts handover performance.

### SUMMARY

The present disclosure for resolving the above-described problems is directed to providing a method and an apparatus for selecting an optimal beam in an O-RAN system.

A method of a service management and orchestration framework (SMO), according to an exemplary embodiment of the present disclosure for achieving the above-described objective, may comprise: transmitting, to an E2 node, a data collection request message for training an artificial intelligence (AI)/machine learning (ML) model; receiving, from the E2 node, first data collected for training the AI/ML model; and providing the collected first data to a non-real time radio access network (RAN) intelligent controller (RIC) to train the AI/ML model, wherein the AI/ML model is an AI/ML model for Grid-of-Beams (GoB) beamforming or an AI/ML model for beam selection.

The data collection request message and the first data may be transmitted through an O1 interface.

The first data may include at least one of: a user equipment (UE)-specific channel state information (CSI) report, UE-specific statistical CSI, UE-specific layer 1-received signal received power (L1-RSRP) measurement information, UE-specific CSI reference signal (CSI-RS) resource indicator (CRI) and synchronization signal (SS)/physical broadcast channel (PBCH) block resource indicator (RI), a UE-specific average downlink throughput at a base station (gNB), wideband channel quality indicator (CQI) distribution information, physical downlink shared channel (PDSCH) modulation and coding scheme (MCS) distribution information, or a beam prediction accuracy-related key performance indicator (KPI).

The method may further comprise: transmitting, to the E2 node, a data collection request message for inference using the AI/ML model; receiving, from the E2 node, second data collected for inference using the AI/ML model; transmitting the second data to the non-real time RIC so that the non-real time RIC performs inference using the AI/ML model and generates configuration information of the AI/ML model; and providing the configuration information of the AI/ML model to the E2 node.

The second data may maintain consistency in type and structure with the first data.

The method may further comprise: transmitting, to the E2 node, a data collection request message for performance evaluation of the AI/ML model; receiving, from the E2 node, third data collected for performance evaluation of the AI/ML model; and transmitting the third data to the non-real time RIC so that the non-real time RIC performs efficiency monitoring and evaluation of the AI/ML model.

The method may further comprise: in response to receipt of update information of the AI/ML model from the non-real time RIC, transmitting the update information of the AI/ML model to the E2 node.

The third data may maintain consistency in type and structure with the first data.

The E2 node may include at least one of a central unit (O-CU) of an open RAN (O-RAN), a distributed unit (O-DU) of the O-RAN, or a radio unit (O-RU) of the O-RAN.

A method of a non-real time RAN intelligent controller (RIC), according to an exemplary embodiment of the present disclosure, may comprise: receiving, from a service management and orchestration framework (SMO), first data collected for training an artificial intelligence (AI)/machine learning (ML) model, the first data being collected from E2 nodes; training the AI/ML model based on the first data; and transmitting the trained AI/ML model to the E2 nodes via the SMO, wherein the AI/ML model is an AI/ML model for Grid-of-Beams (GoB) beamforming or an AI/ML model for beam selection.

The first data may include at least one of: a user equipment (UE)-specific channel state information (CSI) report, UE-specific statistical CSI, UE-specific layer 1-received signal received power (L1-RSRP) measurement information, UE-specific CSI reference signal (CSI-RS) resource indicator (CRI) and synchronization signal (SS)/physical broadcast channel (PBCH) block resource indicator (RI), a UE-specific average downlink throughput at a base station (gNB), wideband channel quality indicator (CQI) distribution information, physical downlink shared channel (PDSCH) modulation and coding scheme (MCS) distribution information, or a beam prediction accuracy-related key performance indicator (KPI).

The method may further comprise: receiving second data for inference of the AI/ML model from E2 node(s) via the SMO; performing inference using the AI/ML model based on the second data; generating configuration information of the AI/ML model based on the inference of the AI/ML model; and providing the configuration information of the AI/ML model to the E2 node(s).

The method may further comprise: receiving third data for performance evaluation of the AI/ML model from E2 node(s) via the SMO; monitoring efficiency of the AI/ML model based on the third data; and generating evaluation information of the AI/ML model based on a result of the monitoring of the efficiency of the AI/ML model.

A service management and orchestration framework (SMO), according to an exemplary embodiment of the present disclosure, may comprise at least one processor, and the at least one processor causes the SMO to perform: transmitting, to an E2 node, a data collection request message for training an artificial intelligence (AI)/machine learning (ML) model; receiving, from the E2 node, first data collected for training the AI/ML model; and providing the collected first data to a non-real time radio access network (RAN) intelligent controller (RIC) to train the AI/ML model, wherein the AI/ML model is an AI/ML model for Grid-of-Beams (GoB) beamforming or an AI/ML model for beam selection.

The data collection request message and the first data may be transmitted through an O1 interface.

The first data may include at least one of: a user equipment (UE)-specific channel state information (CSI) report, UE-specific statistical CSI, UE-specific layer 1-received signal received power (L1-RSRP) measurement information, UE-specific CSI reference signal (CSI-RS) resource indicator (CRI) and synchronization signal (SS)/physical broadcast channel (PBCH) block resource indicator (RI), a UE-specific average downlink throughput at a base station (gNB), wideband channel quality indicator (CQI) distribution information, physical downlink shared channel (PDSCH) modulation and coding scheme (MCS) distribution information, or a beam prediction accuracy-related key performance indicator (KPI).

The at least one processor may further cause the SMO to perform: transmitting, to the E2 node, a data collection request message for inference using the AI/ML model; receiving, from the E2 node, second data collected for inference using the AI/ML model; transmitting the second data to the non-real time RIC so that the non-real time RIC performs inference using the AI/ML model and generates configuration information of the AI/ML model; and providing the configuration information of the AI/ML model to the E2 node.

The second data may maintain consistency in type and structure with the first data.

The at least one processor may further cause the SMO to perform: transmitting, to the E2 node, a data collection request message for performance evaluation of the AI/ML model; receiving, from the E2 node, third data collected for performance evaluation of the AI/ML model; and transmitting the third data to the non-real time RIC so that the non-real time RIC performs efficiency monitoring and evaluation of the AI/ML model.

The at least one processor may further cause the SMO to perform: in response to receipt of update information of the AI/ML model from the non-real time RIC, transmitting the update information of the AI/ML model to the E2 node.

According to exemplary embodiments of the present disclosure, a non-real time RIC included in an SMO can generate and configure an AI/ML model for Grid-of-Beams (GoB) beamforming optimization. Furthermore, according to exemplary embodiments of the present disclosure, the non-real time RIC can provide the AI/ML model for GoB beamforming optimization not only to a near-real time RIC but also to E2 nodes. Through this, each UE can receive services based on the optimized beamforming. Additionally, according to exemplary embodiments of the present disclosure, the non-real time RIC has the advantage of enabling selection of the optimal beam for each UE at a time slot for service provision by training and inference of an AI/ML model for beam selection from GoB.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram of an O-RAN architecture defined by the O-RAN alliance.

FIG. 4A is a conceptual diagram of an SMO framework defined by the O-RAN alliance.

FIG. 4B is a conceptual diagram of a non-real time RIC architecture within the SMO framework as defined by the O-RAN alliance.

FIG. 5A is a conceptual diagram illustrating a near-real time RIC architecture defined by the O-RAN alliance.

FIG. 5B is a conceptual diagram illustrating functions that may be included in a near-real time RIC platform within the O-RAN system.

FIG. 6 is a conceptual diagram illustrating an AI/ML-based beam selection optimization structure and its operations.

FIG. 7 is a timing diagram illustrating a time-domain operation of beam selection optimization in O-RAN.

FIG. 8A is a conceptual diagram illustrating some components related to beam selection optimization in O-RAN.

FIG. 8B is a conceptual diagram illustrating the remaining components among the components related to beam selection optimization in O-RAN.

FIG. 9 is a conceptual diagram illustrating interfaces between O-RAN components and operations in which information related to beam selection optimization is transmitted.

FIG. 10 is a conceptual diagram illustrating AI/ML operations for GoB beamforming optimization performed in a non-real time RIC.

FIG. 11A is a sequenced chart illustrating a training procedure in an AI/ML-based GoB beamforming optimization procedure.

FIG. 11B is a sequence chart illustrating an inference and GoB beamforming optimization procedure in the AI/ML-based GoB beamforming optimization procedure.

FIG. 11C is a sequence chart illustrating an efficiency monitoring and AI/ML model update procedure in the AI/ML-based GoB beamforming optimization procedure.

FIG. 12 is a conceptual diagram illustrating AI/ML operations for beam selection optimization in a near-real time RIC.

FIG. 13A is a sequence chart illustrating a training procedure in an AI/ML-based beam selection optimization procedure.

FIG. 13B is a sequence chart illustrating an inference and beam selection optimization procedure in the AI/ML-based beam selection optimization procedure.

FIG. 13C is a sequence chart illustrating an efficiency monitoring and AI/ML model update procedure in the AI/ML-based beam selection optimization procedure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

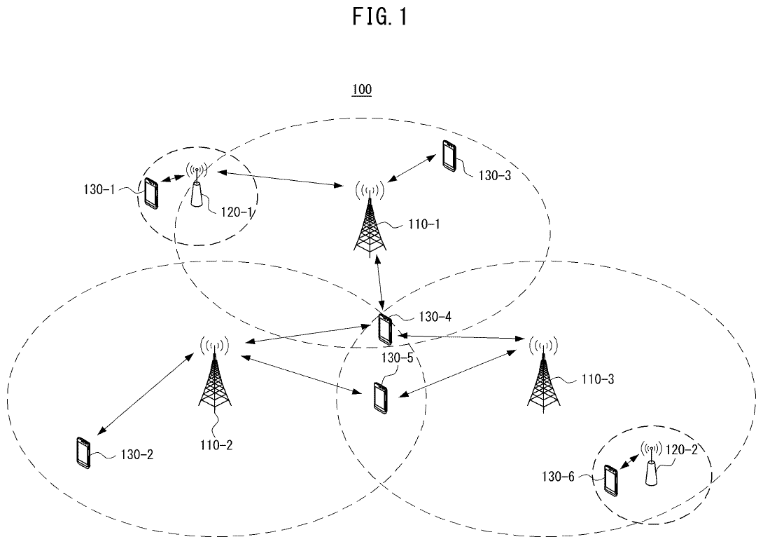

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

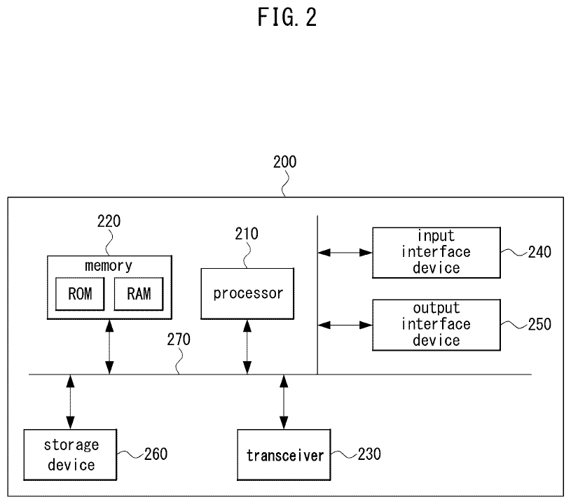

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (COMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

Meanwhile, O-RAN pursued by the O-RAN alliance literally refers to an open radio access network and encompasses all technologies that enable interoperability between base station equipment from different manufacturers. Therefore, O-RAN specifically includes hardware (HW) and software (SW) components that constitute the RAN, as well as all standardized interfaces between these components.

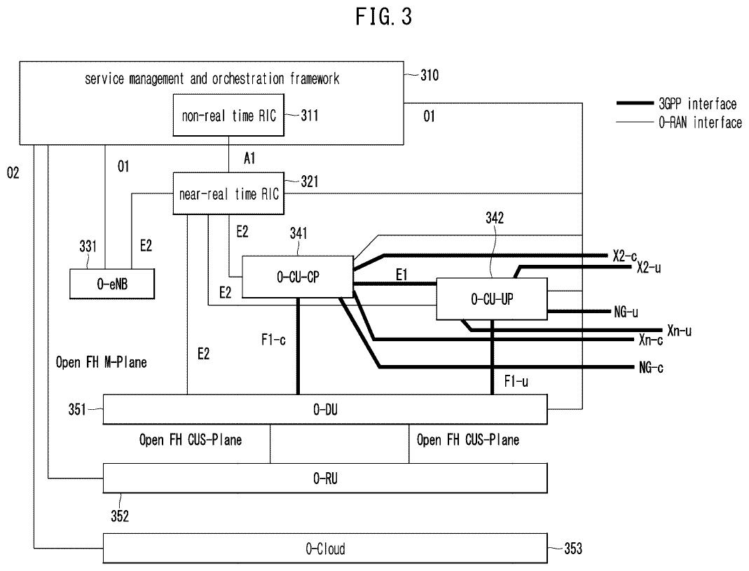

FIG. 3 is a conceptual diagram of an O-RAN architecture defined by the O-RAN alliance.

Referring to FIG. 3, a service management and orchestration framework (SMO) 310 may include a non-real time RAN intelligent controller (RIC) 311. The SMO 310 may be connected to a near-real time RIC 321, O-eNB 331, O-CU-CP 341, O-CU-UP 342, and O-DU 351 through O1 interfaces. Additionally, the SMO 310 may be connected to an O-RU 352 through an open fronthaul (FH) M-Plane interface and to an O-Cloud 353 through an O2 interface.

Here, the O-CU refers to a central unit (CU) of the O-RAN, the O-DU refers to a distributed unit (DU) of the O-RAN, and the O-RU refers to a radio unit (RU) of the O-RAN. Furthermore, relationships between a control plane (CP) and a user plane (UP) are described. Therefore, the O-CU-CP 341 may refer to a CP included in the O-CU, and the O-CU-UP 342 may refer to a UP included in the O-CU.

The near-real time RIC 321 may be connected to the O-eNB 331, O-CU-CP 341, O-CU-UP 342, and O-DU 351 through E2 interfaces. Additionally, the near-real time RIC 321 may be connected to the non-real time RIC 311 through an A1 interface.

The O-CU-CP 341 may be connected to the O-CU-UP 342 through an E1 interface and to the O-DU 351 through an F1-c interface. Additionally, the O-CU-CP 341 may be connected to other nodes in the 3GPP network through an X2-c interface, Xn-c interface, and NG-c interface.

The O-CU-UP 342 may be connected to the O-DU 351 through an F1-u interface. Additionally, the O-CU-UP 342 may be connected to other nodes in the 3GPP network through an X2-u interface, Xn-u interface, and NG-u interface.

The O-DU 351 may be connected to the O-RU 352 through an open FH CUS-plane interface and open FH M-Plane interface.

The non-real time RIC 311 included in the SMO 310 is a logical function block that may perform non-real time control on RAN components and resources by collecting granular data through the O1 interfaces. More specifically, the non-real time RIC 311 may manage the overall network configuration through granular data collection and provide recommendations to the near-real time RIC 321 by obtaining artificial intelligence (AI)-based feeds. The non-real time RIC 311 may provide policy, enrichment information, and machine learning (ML) model management information for the near-real time RIC 321 through the A1 interface. Furthermore, the non-real time RIC 311 may receive policy feedback from the near-real time RIC 321 through the A1 interface.

The near-real time RIC 321 is a logical function block that performs near-real time control, optimizes RAN components and resources, executes AI/ML workflows including model training and updates, and may provide policy-based guidance for applications within the near-real time RIC 321. The near-real time RIC 321 may control the RAN using extended applications (xApps). The near-real time RIC 321 may enable near-real time control optimization of RAN components (referred to as E2 nodes) through tasks transmitted through the E2 interfaces, which are open interfaces. The near-real time RIC 321 may transmit RIC control and policies to RAN components through the E2 interfaces and may receive feedback in response.

The xApps may control operations such as handover optimization, radio link monitoring, radio resource management, mobility management, load balancing, slicing policy updates, traffic coordination, interference management, and security. In other words, a first xApp may be an application for handover optimization, and a second xApp may be an application for radio link monitoring. Various types of xApps that operate within the near-real time RIC 321 may be introduced as described above.

The O-eNB 331 may refer to a third-generation (3G) base station or a fourth-generation (4G) base station that may connect to the SMO 310 of the O-RAN. Additionally, the O-eNB 331 may be connected to the near-real time RIC 321 through the E2 interface. Therefore, the O-eNB 331 may be controlled by an xApp deployed in the near-real time RIC 321 or may provide feedback with information requested by the xApp deployed in the near-real time RIC 321. Other operations thereof may be the same as those of 3G and 4G base stations.

The O-CU-CP 341 is a logical node that serves as a CU-CP of O-RAN according to the specifications of the O-RAN alliance and may host a radio resource control (RRC) and control plane portion of a packet data convergence protocol (PDCP).

The O-CU-UP 342 is a logical node that serves as an O-CU-user plane (UP) of O-RAN according to the specifications of the O-RAN alliance and may host a user plane portion of the PDCP and a service data adaptation protocol (SDAP).

The O-DU is a logical node based on a lower-layer functional split of the O-CU (including O-CU-CP 341 and O-CU-UP 342) and may host a radio link control (RLC) layer, medium access control (MAC) layer, and high-physical (High-PHY) layer.

The O-RU 352 is a logical node that may host a low-physical (Low-PHY) layer and RF processing based on the lower-layer functional split.

The O-Cloud 353 may be a set of hardware and software that provides cloud computing for hosting and executing O-RAN network functions.

The O-RAN described above defines a virtualized form of RAN on open hardware. Additionally, the O-RAN defines standardized interfaces in compliance with 3GPP and relevant mobile communication standards to enable an open and highly compatible supply ecosystem. Furthermore, as described above, the RIC is divided into the non-real time RIC 311 and the near-real time RIC 321 to facilitate AI and/or ML-based RAN control.

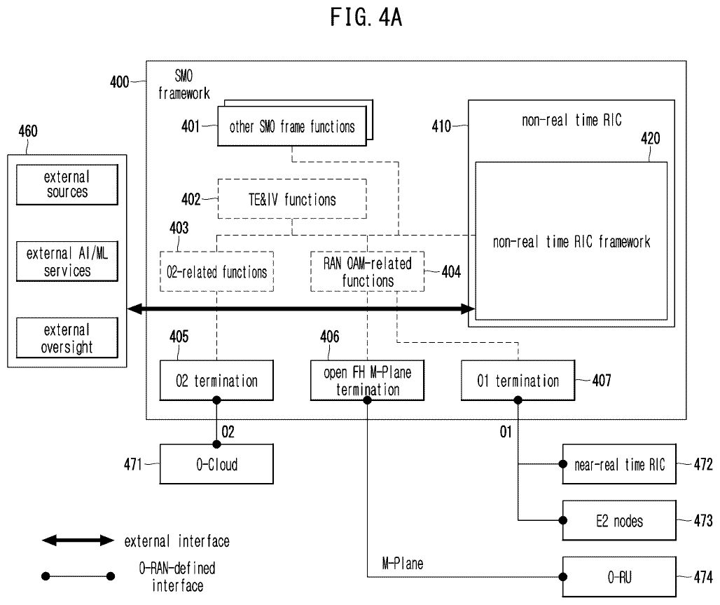

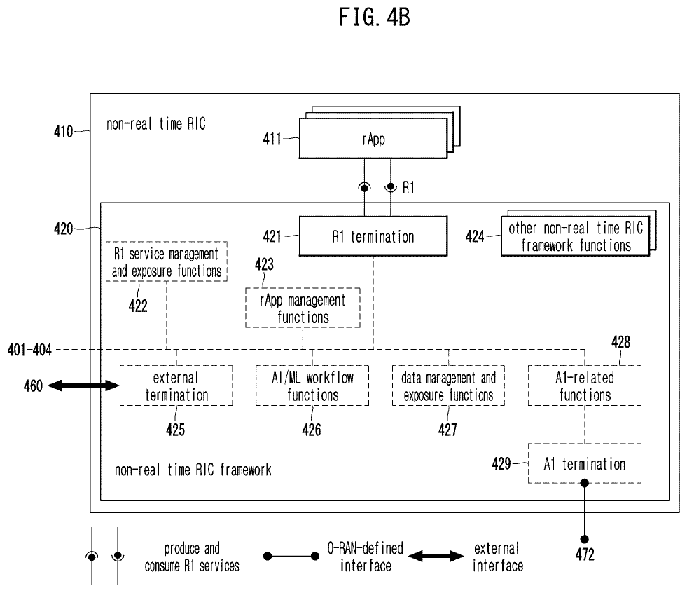

FIG. 4A is a conceptual diagram of an SMO framework defined by the O-RAN alliance.

Referring to FIG. 4A, an SMO framework 400 and external devices, nodes, or clouds located outside the SMO 400 are illustrated. The external components of the SMO 400 include external devices 460, O-Cloud 471, near-real time RIC 472, E2 nodes 473, and O-RU 474.

First, describing the devices located outside the SMO framework 400, the external devices 460 may include external sources, external AI/ML services, and external oversight. The O-Cloud 471, which is located outside the SMO framework 400, may refer to a set of hardware and software that provides cloud computing capabilities for hosting and executing O-RAN network functions. The E2 nodes 473, which are located outside the SMO framework 400, may refer to nodes that use the E2 interfaces, including DUs and CU(s) in 5G, as well as an eNB that is compatible with O-RAN in 4G. The O-RU 474, which is located outside the SMO framework 400, may be an RU of O-RAN, which is a logical node that performs Low-PHY layer functions and RF processing based on the lower-layer functional split.

The SMO framework 400 may include the non-real time RIC 410, other SMO frame functions 401, topology exposure and inventory (TE&IV) functions 402, O2-related functions 403, RAN OAM-related functions 404, O2 termination 405, open FH M-Plane termination 406, and O1 termination 407.

The non-real time RIC 410 may include a non-real time RIC framework 420. The non-real time RIC 410 may provide an A1 interface to a near-real time RIC 472. A specific configuration of the non-real time RIC 410 and the non-real time RIC framework 420 is further described in FIG. 4B.

The TE&IV functions 402 may provide TE&IV services within the SMO framework 400. The O2-related functions 403 may be functions that provide the O2 interfaces. The RAN OAM-related functions 404 may be functions related to the operations, administration, and management (OAM) of the RAN.

The TE&IV functions 402, the O2-related functions 403, and the OAM-related functions 404, which are indicated by dashed lines in FIG. 4A, may be non-anchored functions.

The O2 termination 405 is a termination of the O2 interfaces within the SMO framework 400 and may provide connections to the O-Cloud 471 through the O2 interfaces. The O2 interface is an open logical interface within the O-RAN architecture and may provide secure communication between the SMO framework 400 and the O-Cloud 471.

The open FH M-Plane termination 406 is an M-Plane termination within the SMO framework 400 and may provide connections to the O-RU 474 through the M-Plane. The M-Plane may transmit management messages between RU and DU using a Transmission Control Protocol (TCP).

The O1 termination 407 is a termination of the O1 interfaces within the SMO framework 400 and may provide connections to the near-real time RIC 472 and the E2 nodes 473 through the O1 interfaces. The O1 interfaces are logical connections between all O-RAN management elements (ME) and a ‘management entity’ within the SMO framework and may ensure operations and management, including software management and file management of O-RAN components.

FIG. 4B is a conceptual diagram of a non-real time RIC architecture within the SMO framework as defined by the O-RAN alliance.

Referring to FIG. 4B, the non-real time RIC may include RAN intelligent controller applications (rApps) 411 and a non-real time RIC framework 420. The rApps 411 and the non-real time RIC framework 420 may produce and consume R1 services through R1 interfaces. The non-real time RIC 410 may also function as a platform for executing the rApps 411 and may provide all necessary functions for the operations of the rApps 411.

The rApps 411 may be software programs executed in the non-real time RIC 410. Therefore, the rApps 411 may perform network management and optimization tasks that do not require immediate real-time responses.

The non-real time RIC framework 420 may include an R1 termination 421, R1 service management and exposure functions 422, rApp management functions 423, other non-real time RIC framework functions 424, external termination 425, AI/ML workflow functions 426, data management and exposure functions 427, A1-related functions 428, and A1 termination 429.

The R1 termination 421 is a termination that provides an interface for communicating with the rApps 411 and may provide interfaces between various entities within the non-real time RIC framework 420 and the rApps 411. Other operations within the non-real time RIC framework may be provided by the other non-real time RIC framework functions 424.

The R1 service management and exposure functions 422, the rApp management functions 423, the external termination 425, the AI/ML workflow functions 426, the data management and exposure functions 427, and the A1-related functions 428, which are indicated by dashed lines in FIG. 4B, may be non-anchored functions.

The A1 termination 429 is a termination of the A1 interface within the non-real time RIC framework 420 and may enable communication between RICs through the A1 interface. The A1 interface may support policy management, data transfer, and ML management.

The non-real time RIC 410 may optimize RAN functions (e.g. intelligent radio resource management) by providing policy-based guidance to the near-real time RIC 472, with a processing time of more than one second. Additionally, the non-real time RIC 410 may train AI/ML models and/or perform inference using AI/ML models. The non-real time RIC 410 may provide enrichment information to the near-real time RIC 472 through the A1 interface. The near-real time RIC 472 may receive the enrichment information to support intelligent RAN operation and optimization.

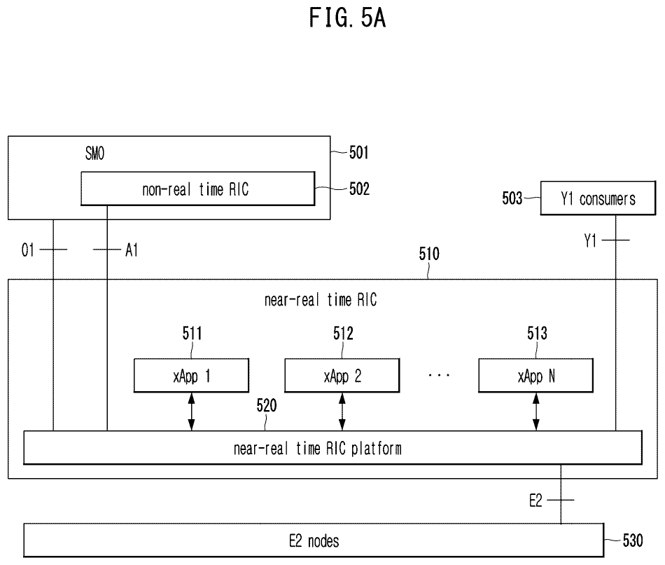

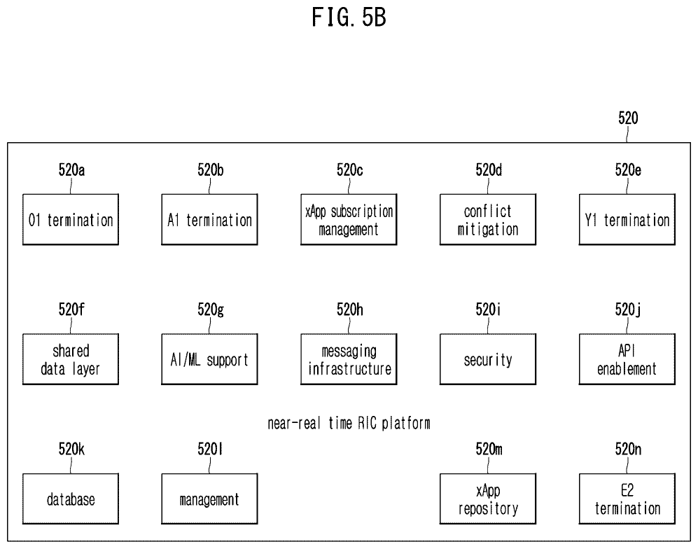

FIG. 5A is a conceptual diagram illustrating a near-real time RIC architecture defined by the O-RAN alliance.

Referring to FIG. 5A, an SMO 501 including a non-real time RIC 502 is illustrated, which may be the same as those described in FIG. 4A and FIG. 4B. Y1 consumers 503 may receive RAN analytics information from a near-real time RIC 510 through Y1 interfaces. The Y1 consumers 503 may be entities located inside or outside a trusted domain of a Public Land Mobile Network (PLMN) that utilize Y1 RAN analytics information generated by the near-real time RIC 510.

The near-real time RIC 510 may include multiple xApps 511, 512, . . . , and 513 and a near-real time RIC platform 520. Each of the multiple xApps 511, 512, . . . , and 513 may be a software application used to implement a specific function or service in near-real time in the near-real time RIC 510 within the O-RAN architecture. The services provided by the multiple xApps 511, 512, . . . , and 513 may include radio resource management, mobility management, and security.

The near-real time RIC platform 520 may communicate with the SMO 501 using the O1 interface and may communicate with the non-real time RIC 502 using the A1 interface. Additionally, the near-real time RIC platform 520 may communicate with the E2 nodes 530 using the E2 interfaces.

The near-real time RIC platform 520 may include O1 termination, A1 termination, xApp subscription management, conflict mitigation, Y1 termination, shared data layer, AI/ML support, messaging infrastructure, security, application programming interface (API) enablement, a database, management, xApp repository, and E2 termination.

The near-real time RIC 510 may have a control time ranging from 10 milliseconds to 1 second and may provide near-real time services and radio resource management functions to E2 nodes based on data collection and operations through the E2 interface. The near-real time RIC 510 may collect cell/UE information from the E2 nodes 530 using the E2 interfaces. The near-real time RIC 510 may host one or more xApps for specific purposes to control and optimize the services and resources of the E2 nodes in near-real time. Additionally, the near-real time RIC 510 may adjust the xApps 511 according to the policies and enrichment information provided by the non-real time RIC 502 through the A1 interface, generate RAN analytics information based on available data, and make this information available through the Y1 interface.

FIG. 5B is a conceptual diagram illustrating functions that may be included in a near-real time RIC platform within the O-RAN system.

Referring to FIG. 5B, the near-real time RIC platform 520 may include an O1 termination 520a, A1 termination 520b, xApp subscription management 520c, conflict mitigation 520d, Y1 termination 520e, shared data layer 502f, AI/ML support 520g, messaging infrastructure 520h, security 520i, API enablement 520j, database 520k, management 520l, xApp repository 520m, and E2 termination 520n.

The near-real time RIC platform 520 may include only a part of the components illustrated in FIG. 5B. In another example, the near-real time RIC platform 520 may include additional components beyond those illustrated in FIG. 5B.

The O1 termination 520a is a termination of the O1 interface for communication with the SMO 501 and may provide a connection between the SMO 501 and the near-real time RIC platform 520 using the O1 interface. The A1 termination 520b is a termination of the A1 interface for communication with the non-real time RIC 502 included in the SMO 501 and may provide a connection between the non-real time RIC 502 and the near-real time RIC platform 520 using the A1 interface.

The xApp subscription management 520c may refer to a process that controls subscription procedures of xApps operating within the near-real time RIC 510 and manages the xApps 511, 512, . . . , and 513 operating within the near-real time RIC 510. The conflict mitigation 520d may refer to a process for identifying and resolving conflicts within the O-RAN system to ensure reliable and efficient operation.

The Y1 termination 520e is a termination of the Y1 interface for providing Y1 RAN analytics information to the Y1 consumers 503 within the near-real time RIC platform 520. The Y1 termination 520e may provide connections (or communications) between the Y1 consumers 503 and the near-real time RIC platform 520 using the Y1 interfaces. The shared data layer 502f may refer to a high-speed, lightweight interface for accessing a shared data repository. The AI/ML support 520g may be a process for supporting AI/ML functions within the near-real time RIC 520. The messaging infrastructure 520h may be a process for managing messages transmitted through the near-real time RIC platform 520. The security 520i may be a process related to security, and the API enablement 520j may be a process for controlling activation of the API.

The database 520k may be a memory region for storing data managed within the near-real time RIC platform 520. The management 520l may be a process for managing other processes within the near-real time RIC platform 520. The xApp repository 520m may be a memory region for storing open-source code of prototype xApps. The E2 termination 520n is a termination of the E2 interfaces for communication with the E2 nodes 530, and the E2 termination 520n may provide connections between the E2 nodes 530 and the near-real time RIC platform 520.

Meanwhile, the E2 nodes illustrated in FIG. 4A and FIG. 5A may be defined as logical nodes connected to the E2 interfaces. The E2 nodes may include an O-RAN central unit-control plane (O-CU-CP), O-RAN central unit-user plane (O-CU-UP), an O-RAN distributed unit (O-DU), and an O-RAN eNB (O-eNB). The O-CU may be a function block responsible for higher layers of a base station and may be divided into a control plane, O-CU-CP, which delivers control information, and a user plane, O-CU-UP, which delivers traffic. Therefore, the O-CU-CP may perform RRC and a control part of PDCP, while the O-CU-UP may perform a user part of PDCP and SDAP. The O-DU may be responsible for RLC, MAC, and High-PHY layers in the base station. The O-eNB may be an LTE base station capable of supporting O-RAN functions. Primary targets of the E2 nodes may be the O-CU and/or O-DU.

The O-RAN radio unit (O-RU) may correspond to the Low-PHY layer in the base station, and role distribution between the O-RU and the High-PHY layer of the O-DU may follow the standardized functional split options defined by the O-RAN alliance. Therefore, the O-RU may primarily perform radio signal processing. Unlike other function blocks of O-RAN, the O-RU may be implemented and/or deployed as a Physical Network Function (PNF). Additionally, an open fronthaul (open FH) interface is defined between the O-RU and the O-DU.

The present disclosure relates to a beam selection optimization technique, which is one of detailed techniques addressed in the use cases of massive MIMO in O-RAN. The beam selection optimization technique is one of the massive MIMO beamforming optimization techniques, and the O-RAN working group (WG) 1 and relevant WGs specify and present various methods and procedures that can be implemented within the O-RAN architecture.

The present disclosure describes an AI/ML-based beam selection optimization method that can be implemented in the O-RAN architecture and a device for performing the method. Specifically, the present disclosure describes the O-RAN architecture for implementing AI/ML-based beam selection optimization techniques, roles and functions of components and interfaces, required information and data, and overall procedures.

Unlike conventional mobile communication systems, 5G NR introduces beamforming, and the performance of a mobile communication system may depend on a beamforming method. The communication performance based on beamforming may primarily depend on beamforming pattern design. Generally, beams have been manually and semi-statically configured based on empirical knowledge of mobile communication experts and passive test results. As a result, the system may not actively respond to real-time changes in situational information, which may lead to high inter-cell interference, low performance at cell edges due to inter-cell interference, traffic imbalance between adjacent cells, and degraded handover performance due to traffic imbalance.

Additionally, selecting a beam to be actually used from a given beamforming pattern may be crucial. However, achieving precise beam alignment between a base station and a UE remains a significant challenge. To achieve accurate beam alignment, communication nodes need to frequently measure and report beam qualities for all available beams, which may incur considerable costs. The costs may include power consumption and/or radio resource consumption.

If a highly mobile UE does not frequently perform beam measurements and reports, a connection between the base station and the UE may be easily interrupted due to UE movement or blockage by obstacles. Therefore, balancing network performance improvement with the associated costs and overhead may be of utmost importance.

Various methods have been proposed to address these issues, and recently, methods applying AI/ML technology, which has been actively utilized in many other fields, have been explored.

The following describes an AI/ML-based beam selection optimization method in O-RAN.

The O-RAN is structurally capable of applying AI/ML technologies through the RIC, and since the use case of massive MIMO is prioritized in WG1, defining a detailed procedure for AI/ML-based beam selection optimization related to massive MIMO beamforming optimization is required. Accordingly, the present disclosure describes a structure of an AI/ML-based beam selection optimization method operating in the O-RAN architecture, functions of each O-RAN component, interfaces between the components, information exchanged through the interfaces, and procedures therefor.

### AI/ML-Based Beam Selection Optimization Structure

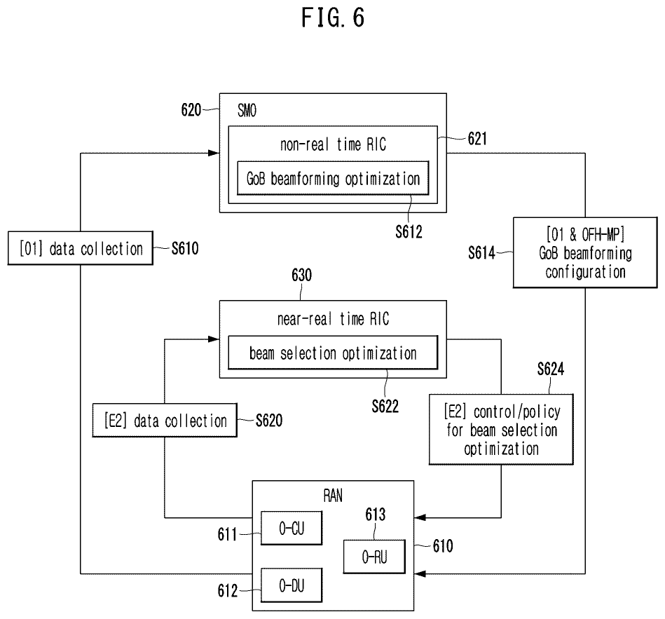

FIG. 6 is a conceptual diagram illustrating an AI/ML-based beam selection optimization structure and its operations.

Referring to FIG. 6, an AI/ML-based beam selection optimization structure according to an exemplary embodiment of the present disclosure may include an RAN 610, SMO 620 including a non-real time RIC 621, and a near-real time RIC 630. The RAN 610 may include an O-CU 611, O-DU 612, and O-RU 613, as described previously.

The procedure illustrated in FIG. 6 may consist of two stages. The first stage, which involves steps S610, S612, and S614, may be a procedure performed in the non-real time RIC 621 of the SMO 620 to optimize Grid-of-Beams (GoB) beamforming. The GoB may include techniques for GoB precoding. The GoB precoding is a codebook-based precoding technique used in 5G systems, which may operate by dividing the space into a beam grid. A base station (gNB) may select a subset of beams for data transmission to a UE based on a likelihood of reception at the UE. In this case, the number of beams in the GoB may be determined according to the number of antennas in an antenna array of the gNB.

The second stage, which involves steps S620, S622, and S624, may be a beam selection optimization procedure performed in the near-real time RIC 630. The beam selection optimization procedure may determine a beam used in the RAN 610 and a transmission power for transmitting the beam.

First, the first stage is described. In step S610, the RAN 610 may provide data collected from the O-CU 611, O-DU 612, and O-RU 613 to the non-real time RIC 621 of the SMO 620 through the O1 interface. The provided data may include beam quality measurement report values for candidate beam sets determined for GoB beamforming optimization. The procedure for reporting the beam quality measurements of candidate beam sets may be performed in advance, and it should be noted that this procedure is not illustrated in FIG. 6.

In step S612, the non-real time RIC 621 may perform GoB beamforming optimization using the received data, that is, the beam quality measurement report values of the candidate beam sets. The GoB beamforming optimization may include an operation to determine an appropriate beamforming pattern for the current environment. Here, the current environment may refer to an RAN environment based on the data collected from the O-CU 611, O-DU 612, and O-RU 613.

The GoB beamforming optimization procedure performed by the non-real time RIC 621 may include AI/ML model training and inference procedures to satisfy predefined objectives. In other words, the GoB beamforming optimization procedure performed by the non-real time RIC 621 may first include an operation of receiving measurement information and KPI data for AI/ML model training and inference. Additionally, the GoB beamforming optimization procedure performed by the non-real time RIC 621 may include an operation of training the AI/ML model and/or performing inference using the AI/ML model. Furthermore, the GoB beamforming optimization procedure performed by the non-real time RIC 621 may include an operation of deriving indication information to be applied to each of the O-CU 611, O-DU 612, and O-RU 613 in the RAN 610 based on inference results of the AI/ML model. The indication information may be GoB beamforming configuration indication information.

In step S614, the non-real time RIC 621 may provide the GoB beamforming configuration indication information to each of the O-CU 611, O-DU 612, and O-RU 613 of the RAN 610.

Next, the second stage is described. In step S620, the RAN 610 may provide data collected from the O-CU 611, O-DU 612, and O-RU 613 to the near-real time RIC 630 using the E2 interface. The provided data may include measurement and KPI data for beam selection optimization.

In step S622, the near-real time RIC 630 may perform beam selection optimization using the received data. The beam selection optimization may include an operation of selecting the optimal beam in the current environment. Here, the current environment may refer to an RAN environment based on the data collected from the O-CU 611, O-DU 612, and O-RU 613.

The beam selection optimization procedure performed by the near-real time RIC 630 may also include AI/ML model training and inference procedures to satisfy predefined objectives. In other words, the beam selection optimization procedure performed by the near-real time RIC 630 may be a procedure for selecting the optimal beam among beams being beamformed in the current environment. The near-real time RIC 630 may output beam selection indication information indicating the selected beam.

In step S624, the near-real time RIC 630 may provide the beam selection indication information to each of the O-CU 611, O-DU 612, and O-RU 613 of the RAN 610.

The first stage, which includes steps S610, S612, and S614, and the second stage, which includes steps S620, S622, and S624, may be performed independently. In another example, the second stage may be performed sequentially after the first stage. The first stage, GoB beamforming optimization, may be performed as a long-term process. Since the non-real time RIC 621 has a control time of at least one second, a long duration of at least one second may be required.

On the other hand, the second stage, the beam selection optimization procedure, may be performed as a short-term process. Since the beam selection optimization procedure is performed in the near-real time RIC 630, it may be executed within a time frame of 10 milliseconds to one second, which corresponds to a control time of the near-real time RIC 630.

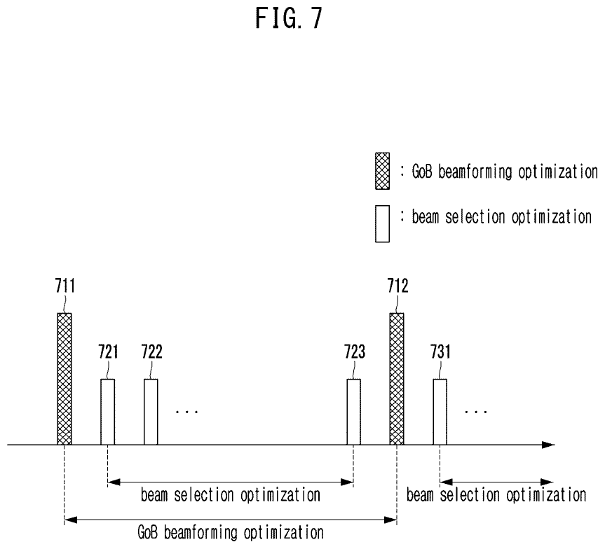

FIG. 7 is a timing diagram illustrating a time-domain operation of beam selection optimization in O-RAN.

Referring to FIG. 7, GoB beamforming optimization operations 711 and 712 may be performed as a long-term process. In contrast, beam selection optimization operations 721, 722, . . . , 723, and 731 may be performed as a short-term process. As illustrated in FIG. 7, the beam selection optimization operations 721, 722, . . . , 723, and 731 may be performed multiple times within a beam selection optimization time, whereas the GoB beamforming optimization operations 711 and 712 may be performed once during a time configured for the GoB beamforming optimization operations.

Generally, after GoB beamforming optimization is performed, beam configuration information changes, so it may be preferable to perform beam selection optimization based on the beam configuration information configured after GoB beamforming optimization.

When operating in this manner, the overall operations may proceed as follows: In step S610, the RAN 610 may collect measurement and performance data for GoB beamforming optimization. In step S612, the non-real time RIC 621 may perform GoB beamforming optimization based on the collected measurement and performance data. In step S614, the GoB beamforming configuration indication may be provided to the RAN 610. Subsequently, in step S620, the RAN 610 may collect measurement and performance data for beam selection optimization and report the collected measurement and performance data to the near-real time RIC 630. In step S622, the near-real time RIC 630 may perform beam selection optimization based on the collected measurement and performance data. Finally, in step S624, the near-real time RIC 630 may provide the beam selection optimization indication to the RAN 610. Additionally, as illustrated in FIG. 7, the steps from S620 to S624 may be repeatedly performed until the first stage is performed again.

### Functions and Interfaces of Components

The following exemplary embodiment describes functions and interfaces of components related to AI/ML-based beam selection optimization, as well as information transmitted through the interfaces.

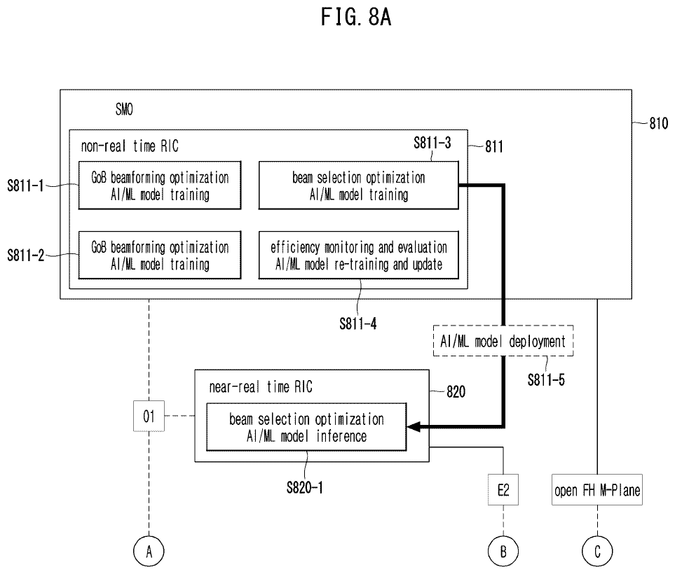

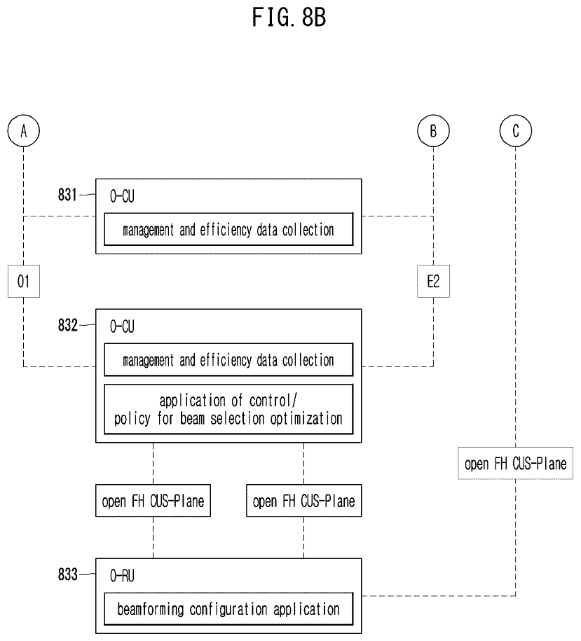

FIG. 8A is a conceptual diagram illustrating some components related to beam selection optimization in O-RAN, and FIG. 8B is a conceptual diagram illustrating the remaining components among the components related to beam selection optimization in O-RAN.

The components of FIGS. 8A and 8B may be connected therebetween via circles denoted as ‘A’, ‘B’, and ‘C’, as illustrated in FIGS. 8A and 8B.

Referring to FIG. 8A, an SMO 810 may include a non-real time RIC 811. The SMO 810 may collect KPI, measurement reports, and enrichment information necessary for E2 nodes and an application server. The SMO 810 may transmit the collected data to the non-real time RIC 811 for AI/ML model training and performance monitoring. The SMO 810 may transmit a configuration information file containing optimized GoB beamforming parameters to an O-DU 832 illustrated in FIG. 8B through an O1 interface. Additionally, the SMO 810 may transmit the configuration information file containing the optimized GoB beamforming parameters to an O-RU 833 illustrated in FIG. 8B through an open FH M-Plane interface.

The non-real time RIC 811 may perform GoB beamforming optimization AI/ML model training in step S811-1. The non-real time RIC 811 may perform GoB beamforming optimization AI/ML model inference in step S811-2. The non-real time RIC 811 may perform beam selection optimization AI/ML model training in step S811-3. The non-real time RIC 811 may perform efficiency monitoring and evaluation, and AI/ML model retraining and updates in step S811-4. Additionally, the non-real time RIC 811 may deploy the AI/ML model to a near-real time RIC 820 in step S811-5.

For the above-described operations, the non-real time RIC 811 may interoperate with the SMO 810. For example, the non-real time RIC 811 may request KPI, measurement reports, and enrichment information from the SMO 810 for AI/ML model construction, training, inference, and performance monitoring. The non-real time RIC 811 may monitor the AI/ML model's performance based on the KPI obtained from the SMO 810 and determine whether to retrain, fine-tune, or update the AI/ML model. The non-real time RIC 811 may perform related AI/ML model training and inference using the data obtained from the SMO 810. The non-real time RIC 811 may support AI/ML model deployment to the near-real time RIC 820 and updates therefor through the O1 interface using the SMO 810. Additionally, the non-real time RIC 811 may support communication of enrichment information with the near-real time RIC 820 through the A1 interface.

The near-real time RIC 820 may perform beam selection optimization and AI/ML model inference using the AI/ML model deployed from the non-real time RIC 811 in step S820-1.

Describing the operations of the near-real time RIC 820 in more detail, the near-real time RIC 820 may support execution and updates of the AI/ML model deployed from the non-real time RIC 811. The near-real time RIC 820 may collect measurement report information required for AI/ML model inference from the E2 nodes illustrated in FIG. 8B through the E2 interfaces. The near-real time RIC 820 may perform inference of the related AI/ML model using the data obtained from the E2 nodes. The near-real time RIC 820 may transmit control or policy messages to the E2 nodes for beam selection optimization operations. Additionally, the near-real time RIC 820 may receive enrichment information from the non-real time RIC 811 through the A1 interface.

Referring to FIG. 8B, the O-CU 831 may collect measurement and performance data requested by the SMO 810 and/or the near-real time RIC 820 through the O1 interface and/or the E2 interfaces and provide the collected data to the respective nodes.

The O-DU 832 may also collect measurement and performance data requested by the SMO 810 and/or the near-real time RIC 820 through the O1 interface and/or the E2 interfaces and provide the collected data to the respective nodes. The O-DU 832 may apply the beam selection optimization configuration based on the control and/or policy messages received from the near-real time RIC 820. Additionally, the O-DU 832 may transmit the GoB beamforming configuration information file received from the SMO 810 to the O-RU 833 through the open FH M-Plane interface.

The O-RU 833 may apply the GoB beamforming configuration received from the SMO 810 and/or the O-DU 832 through the open FH M-Plane interface. Accordingly, the O-RU 833 may provide beamforming services to each UE based on the GoB beamforming configuration received from the SMO 810 and/or the O-DU 832.

### (1) Data for AI/ML Model Training, Inference, and Performance Monitoring

The following describes a data flow for AI/ML model training, inference, and performance monitoring. The data for AI/ML model training, inference, and performance monitoring may be the data transmitted to the non-real time RIC 811. As described in FIG. 8A and FIG. 8B, since the non-real time RIC 811 is included in the SMO 810, the data transmitted to the non-real time RIC 811 may first be transmitted to the SMO 810 from other nodes. The SMO 810 may then provide the data received from other nodes to the non-real time RIC 811 for AI/ML model training, inference, and performance monitoring.

The O-DU 832 may provide CSI reports for each UE, including channel quality indicator (CQI), precoding matrix indicator (PMI), layer indicator (LI), rank indicator (RI), and/or channel state information reference signal (CSI-RS) resource indicator (CRI), to the non-real time RIC 811 via the SMO 810. The O-DU 832 may transmit the CSI reports to the SMO 810 using the O1 interface. The CSI reporting may require more than one second. The SMO 810 may provide the received CSI reports to the non-real time RIC 811. In this case, the CSI reporting may be performed based on 3GPP TS 38.214. Additionally, when reporting CSI, if the method defined in 3GPP TS 38.214 is used, a new message may need to be configured, or additional fields may need to be added to an existing message, in order to report the information described in the present disclosure.

The O-DU 832 may transmit statistical CSI data (e.g. channel covariance matrix or other compressed forms of CSI) for each UE to the SMO 810 through the O1 interface. The statistical CSI data may consist of complex values and may require more than one second for its reporting. The SMO 810 may provide the received statistical CSI data to the non-real time RIC 811. In this case, a new measurement and reporting method may be required for reporting the statistical CSI data.

The O-DU 832 may transmit UE-specific L1-RSRP measurement information (e.g. sequence-type) to the SMO 810 through the O1 interface. The L1-RSRP measurement information may consist of dBm values collected over several hours or days for each cell for training purposes. The SMO 810 may provide the L1-RSRP measurement information to the non-real time RIC 811. The L1-RSRP measurement information may be provided to the non-real time RIC 811 based on the methods defined in 3GPP TS 38.214 and 3GPP TS 38.215.

The O-DU 832 may transmit UE-specific CRI and SS/PBCH block resource indicator (SSBRI) information (e.g. sequence-type) to the SMO 810 through the O1 interface. The CRI and SSBRI may be index values collected over several hours or days for each cell for training purposes. The SMO 810 may provide the CRI and SSBRI to the non-real time RIC 811. The CRI and SSBRI may be provided to the non-real time RIC 811 based on the methods specified in 3GPP TS 38.214.

The O-DU 832 may transmit the UE's average throughput for downlink (DL) at the gNB to the SMO 810 through the O1 interface. The UE's throughput for DL at the gNB may be expressed as a data transmission rate per second, for example, in Kb/s, and the UE's throughput for DL at the gNB may be data collected for several hours or days for each cell for performance evaluation. The SMO 810 may provide the UE's throughput for DL at the gNB to the non-real time RIC 811. The information on the UE's throughput for DL at the gNB may be provided to the non-real time RIC 811 based on the methods specified in 3GPP TS 28.552.

The O-DU 832 may transmit wideband CQI distribution information to the SMO 810 through the O1 interface. The wideband CQI distribution information may be an integer and may consist of data collected for several hours or days for each cell for performance evaluation. The SMO 810 may provide the wideband CQI distribution information to the non-real time RIC 811. The CQI distribution information may be provided to the non-real time RIC 811 based on the methods specified in 3GPP TS 28.552.

The O-DU 832 may transmit PDSCH MCS distribution information to the SMO 810 through the O1 interface. The PDSCH MCS distribution information may be an integer and may consist of data collected for several hours or days for each cell for performance evaluation. The SMO 810 may provide the PDSCH MCS distribution information to the non-real time RIC 811. The PDSCH MCS distribution information may be provided to the non-real time RIC 811 based on the methods specified in 3GPP TS 28.552.

The O-DU 832 may transmit beam prediction accuracy-related KPI information (e.g. Top-K/1 beam prediction accuracy) to the SMO 810 through the O1 interface. The beam prediction accuracy-related KPI information may be in percentage form and may consist of data collected for several hours or days for each UE for performance evaluation. The SMO 810 may provide the beam prediction accuracy-related KPI information to the non-real time RIC 811. For measurement and reporting for configuring the beam prediction accuracy-related KPI information, a new message may need to be defined, or additional field(s) may need to be added to an existing report message. As an example of an existing report message, the beam prediction accuracy-related KPI information may be provided to the non-real time RIC 811 based on the methods specified in 3GPP TR 38.843.

The O-DU 832 may optionally transmit beam failure statistics per cell/UE/beam to the SMO 810 through the O1 interface. The beam failure statistics per cell/UE/beam may be expressed as percentage or count values and may consist of data collected for several hours or days for performance evaluation. The SMO 810 may provide the beam failure statistics per cell/UE/beam to the non-real time RIC 811. The beam failure statistics per cell/UE/beam correspond to information described in the present disclosure, and additional methods may need to be defined for measurements therefor. Additionally, to report the beam failure statistics per cell/UE/beam, a new message may need to be defined, or additional field(s) may need to be added to an existing message.

### (2) Data for AI/ML Model Inference

The following describes a data flow for AI/ML model inference. The data for AI/ML model inference may be transmitted to the near-real time RIC 820.

The O-DU 832, as an E2 node, may transmit UE-specific L1-RSRP measurement information to the near-real time RIC 820 through the E2 interface. The UE-specific L1-RSRP measurement information may be in dBm units and may be measured in integer multiples of 100 milliseconds. The UE-specific L1-RSRP measurement information may be transmitted to the near-real time RIC 820 based on the methods defined in 3GPP TS 38.214 and/or 3GPP TS 38.215.

The O-DU 832 may transmit UE-specific L1-SINR measurement information to the near-real time RIC 820 through the E2 interface. The UE-specific L1-SINR measurement information may be in dBm units and may be measured in integer multiples of 100 milliseconds. The UE-specific L1-SINR measurement information may be transmitted to the near-real time RIC 820 based on the methods defined in 3GPP TS 38.214 and/or 3GPP TS 38.215.

The O-DU 832 may transmit UE-specific CRI and SSBRI information to the near-real time RIC 820 through the E2 interface. The UE-specific CRI and SSBRI information may be in dBm units and may be measured in integer multiples of 100 milliseconds. The UE-specific CRI and SSBRI information may be transmitted to the near-real time RIC 820 based on the methods defined in 3GPP TS 38.214.

### (3) Control Information for E2 Node(s)

The following describes control information for E2 node(s). The control information and policy information for E2 node(s) may be provided by the non-real time RIC 811 and may be delivered to the E2 nodes via the SMO 810, as described above.

The non-real time RIC 811 may provide GoB beamforming configuration information to the E2 nodes, including the O-DU 832 and O-RU 833, via the SMO 810. The GoB beamforming configuration information provided to the O-DU 832 may utilize the O1 interface via the SMO 810, as illustrated in FIG. 8A and FIG. 8B, while the GoB beamforming configuration information provided to the O-RU 833 may utilize the open FH M-Plane interface via the SMO 810, as illustrated in FIG. 8A and FIG. 8B. The GoB beamforming configuration information may include a beamforming configuration file (beam pattern), beamforming weights or attribute information, and a beam index set for measurement and reporting. The GoB beamforming configuration information may be provided to the O-RU 833 based on the methods defined in O-RAN.WG4.MP, O-RAN.WG4.CUS, and/or O-RAN.WG5.MP.

The non-real time RIC 811 may provide control/policy information (further described below) for beam management operations to the E2 nodes, including the O-DU 832 and O-RU 833, via the SMO 810. The control/policy information for beam management operations provided to the O-DU 832 may utilize the O1 interface via the SMO 810, as illustrated in FIG. 8A and FIG. 8B, while the control/policy information for beam management operations provided to the O-RU 833 may utilize the open FH M-Plane interface via the SMO 810, as illustrated in FIG. 8A and FIG. 8B. The control/policy information for beam management operations may include beam indication information, such as serving beam indication information for the UE, beam power allocation information, and candidate beam identification information for beam failure recovery. Among the control/policy information for beam management operations, the configuration information may be configured according to 3GPP TS 38.331, and related information elements (related IEs) may be additionally specified in 3GPP TS 38.321.

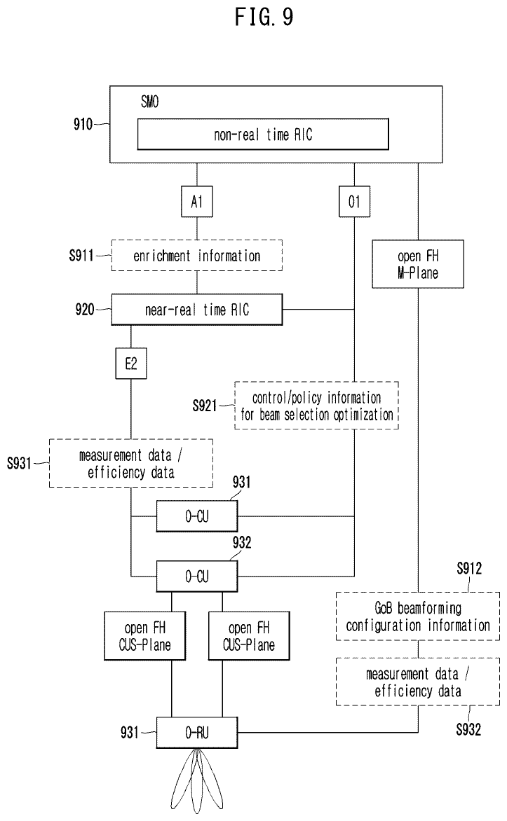

FIG. 9 is a conceptual diagram illustrating interfaces between O-RAN components and operations in which information related to beam selection optimization is transmitted.

The components described in FIG. 9 may be the same as those described in FIG. 8A and FIG. 8B, with the interfaces therefor illustrated. More specifically, an SMO 910 may include a non-real time RIC and may be connected to a near-real time RIC 920 through an A1 interface. In other words, the SMO 910 may communicate with the near-real time RIC 920 through the A1 interface. In step S911, the SMO 910 may transmit enrichment information to the near-real time RIC 920 through the A1 interface, which the non-real time RIC intends to transmit. The SMO 910 may communicate with the O-CU 931 and O-DU 932 through O1 interfaces. Additionally, the SMO 910 may communicate with the O-RU 931 through an open FH M-Plane interface. The SMO 910 may transmit GoB beamforming configuration information, which the non-real time RIC intends to provide to the O-RU 933, to the O-RU 931 through the open FH M-Plane interface.

The near-real time RIC 920 may communicate with the E2 nodes, including the O-CU 931 and O-DU 932, through the E2 interfaces. In step S921, the near-real time RIC 920 may transmit control/policy information for beam selection optimization to the O-CU 931 and O-DU 932 through the E2 interfaces.

The O-DU 932 may communicate with the O-RU 933 through the open FH CUS-Plane interface or the open FH M-Plane interface. In step S931, the O-DU 932 may provide measurement data and/or efficiency data to the near-real time RIC 920 through the E2 interface.

Additionally, the O-RU 933 may receive GoB beamforming configuration information from the SMO 910 through the open FH M-Plane interface in step S912. The GoB beamforming configuration information may correspond to the information transmitted by the non-real time RIC via the SMO 910, as described earlier. The O-RU 933 may transmit measurement data and/or efficiency data to the SMO 910 through the open FH M-Plane interface. The SMO 910 may provide the measurement data and/or efficiency data received from the O-RU 933 to the non-real time RIC.

### AI/ML-Based Beam Selection Optimization Procedure

As described earlier, beam selection optimization may consist of two main stages. The following describes a detailed procedure for each stage. The detailed procedure first defines the overall operational structure, including the required inputs/outputs and pre/post-processing steps needed to build and utilize the AI/ML model to achieve the objectives configured for each stage. Then, a method of implementing these functions in the O-RAN architecture and their operational sequence are defined. Here, it should be noted that the selection and configuration of AI/ML models are implementation issues and are not covered in the present disclosure. In addition, pre/post-processing steps are closely related to input/output data and the AI/ML model to be used, and various implementations are possible. Therefore, no specific method is specified.

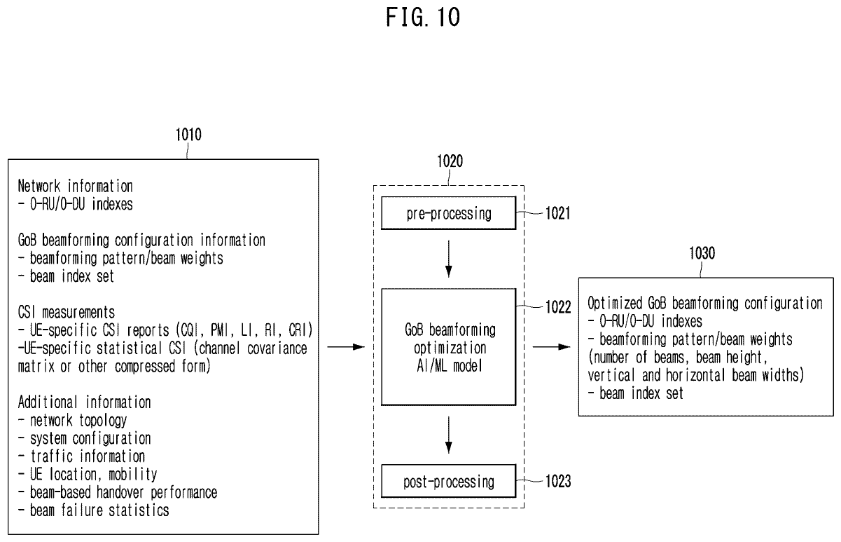

FIG. 10 is a conceptual diagram illustrating AI/ML operations for GoB beamforming optimization performed in a non-real time RIC.

The AI/ML process for GoB beamforming optimization illustrated in FIG. 10 may be performed in the non-real time RIC. The non-real time RIC may receive input information 1010, generate configuration information 1020 for the AI/ML model used in GoB beamforming optimization, and output optimized beamforming configuration information 1030.

The input information 1010 for the AI/ML model used in GoB beamforming optimization may include at least one of the following.
1) Network information: indexes for identifying the O-RU/O-DU
2) GoB beamforming configuration information: the currently configured beamforming pattern, beam weights, or a set of all available beam indexes
3) CSI measurement information: UE CSI reports, including CQI, PMI, LI, RI, and CRI, as well as a covariance matrix or other compressed forms of statistical channel information
4) Additional information: additional information may be optional and may or may not be included in the input information 1010.

The additional information may include network topology information, such as a cell site environment, system configuration details, such as operating frequency, bandwidth, and frame structure, traffic distribution, UE location and mobility information, beam-based handover performance, and beam failure statistics.

The non-real time RIC may generate AI/ML model configuration information 1020 for GoB beamforming optimization based on the input information 1010. The non-real time RIC may use all or only part of the input information 1010. For example, some of the input information 1010 may be used as actual inputs for the AI/ML model, while the remaining information may be utilized as auxiliary data in performing GoB beamforming optimization.

The non-real time RIC may generate AI/ML model inputs from the input information 1010 through a pre-processing block 1021. Therefore, the pre-processing block 1021 may perform an operation that extracts only information required as inputs for the AI/ML model from the input information 1010.

The non-real time RIC may generate output information by training the AI/ML model 1022 or performing inference using the AI/ML model 1022 for GoB beamforming optimization using the information obtained via the pre-processing block 1021.

The output information obtained through training and inference in the AI/ML model 1022 for GoB beamforming optimization may undergo post-processing in a post-processing block 1023. The output information 1030 generated in the post-processing block 1023 may correspond to GoB beamforming optimization outputs, which may be information to be actually directed to the RAN.

Specifically, the output information 1030 may include optimized GoB beamforming configuration, such as O-RU/O-DU indexes for configuring GoB beamforming, the number of beams, a beam direction, beamforming pattern or beam weights including the beam's horizontal and vertical widths, or a subset of beam indexes to be used among the entire available beam index set. The AI/ML model may be selected and designed to generate optimized GoB beamforming configuration in this structure.

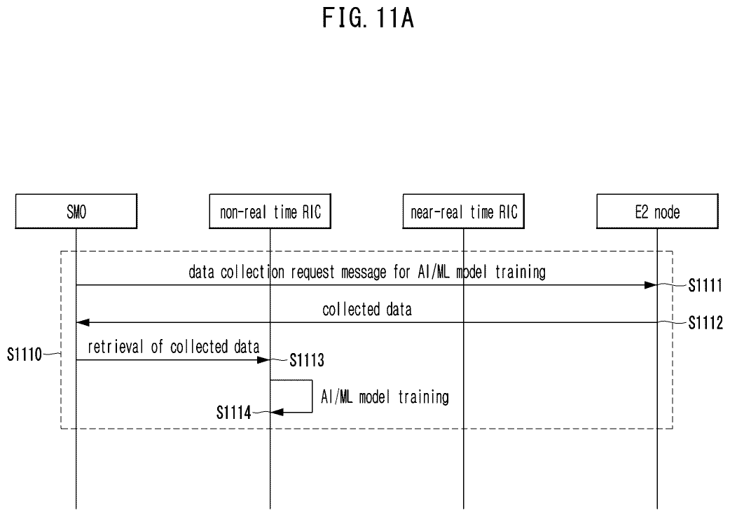

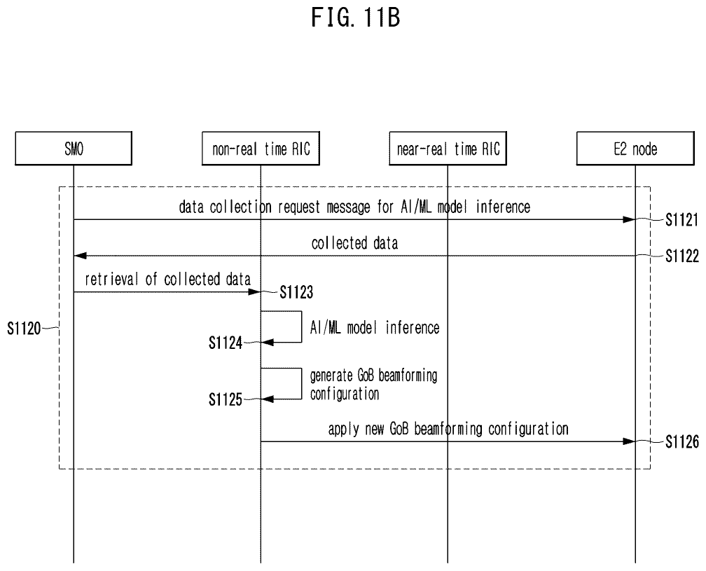

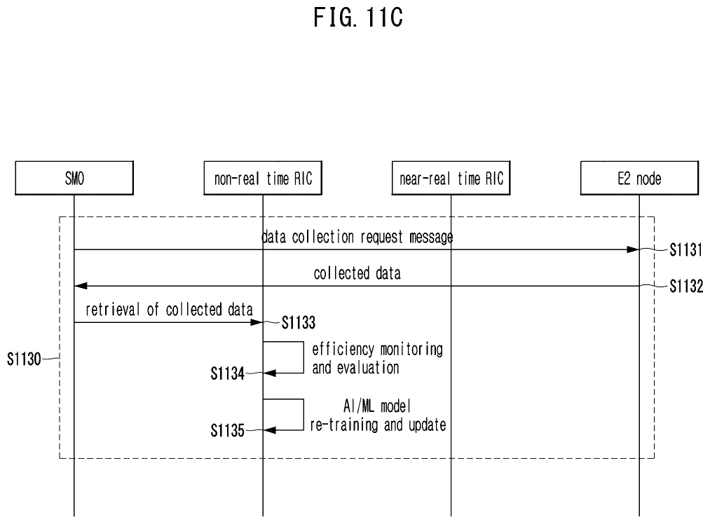

FIG. 11A is a sequenced chart illustrating a training procedure in an AI/ML-based GoB beamforming optimization procedure, FIG. 11B is a sequence chart illustrating an inference and GoB beamforming optimization procedure in the AI/ML-based GoB beamforming optimization procedure, and FIG. 11C is a sequence chart illustrating an efficiency monitoring and AI/ML model update procedure in the AI/ML-based GoB beamforming optimization procedure.

The operations in FIGS. 11A to 11C may be performed sequentially. For example, the training procedure S1110 in FIG. 11A may be performed first, followed by the inference and GoB beamforming optimization procedure S1120 in FIG. 11B, and finally, the efficiency monitoring and AI/ML model update procedure S1130 in FIG. 11C.

In another example, the procedures in FIGS. 11A to 11C may be performed independently of each other. In yet another example, the procedures in FIGS. 11A to 11C may be performed sequentially, but at least one of the procedures—S1110, S1120, or S1130—may be performed multiple times consecutively. In yet another example, the procedures in FIGS. 11A to 11C may be performed sequentially, but an additional procedure not illustrated in FIGS. 11A to 11C may be performed between any two procedures, such as between S1110 and S1120 or between S1120 and S1130.

The training procedure S1110, in which AI/ML model training is performed, is described in more detail with reference to FIG. 11A. The procedure S1110 may be used to select and train an AI/ML model for GoB beamforming optimization, either at an initial stage of system deployment or at long-term intervals. The procedure S1110 may require a very large computational load to select an AI/ML model for GoB beamforming optimization, particularly when performed at the initial stage of system deployment. In other words, a significant amount of time may be required to select an AI/ML model for GoB beamforming optimization. Since the procedure S1110 takes a long time to execute, AI/ML model training may be typically performed in the non-real time RIC within O-RAN, considering control delay constraints.

Referring to FIG. 11A, the non-real time RIC may provide a data collection request message for AI/ML model training to an SMO (not illustrated in FIG. 11A). Accordingly, in step S1111, the SMO may transmit the data collection request message to E2 node(s). Therefore, in step S1111, the E2 node(s) may receive the data collection request message for AI/ML model training from the SMO. In FIG. 11A, a case is assumed where the non-real time RIC provides the data collection request message for AI/ML model training to the SMO. However, the SMO may independently determine whether data collection for AI/ML model training is required and may transmit the data collection request message for AI/ML model training to the E2 node(s).

In step S1112, the E2 node(s) may collect data in response to the data collection request message for AI/ML model training and may transmit the collected data to the SMO. Accordingly, the SMO may receive the collected data.

In steps S1111 and S1112, the message exchanges between the SMO and the E2 node(s) may occur through O1 interface(s). The collected data may include the previously described data, such as CSI measurement information, for AI/ML model training. The transmission of the collected data to the SMO may require the O1 interfaces to be defined in a standardized manner.

In step S1113, the SMO may provide a message requesting retrieval of collected data (i.e. data retrieval message) to the non-real time RIC. Accordingly, in step S1113, the non-real time RIC may receive the collected data retrieval message from the SMO.

In step S1114, the non-real time RIC may train the AI/ML model based on the collected data. The AI/ML model may be selected or generated for GoB beamforming optimization. Although not illustrated in FIG. 11A, an inference result of the AI/ML model for GoB beamforming optimization, generated through training in step S1114, may be provided to the E2 node(s). The inference result of the AI/ML model for GoB beamforming optimization may refer to a file containing control information or beamforming configuration information regarding optimized GoB beamforming resulting from the AI/ML model inference. The file may also be implemented in form of a message containing specific information.

Referring to FIG. 11B, step S1120 may be the inference and GoB beamforming optimization procedure of the AI/ML model. Step S1120 may be a procedure for performing inference using the AI/ML model generated or selected through training in the procedure S1110.

The non-real time RIC may notify the SMO that data is required for AI/ML model inference (not illustrated in FIG. 11B). Based on this, the SMO may transmit a data collection request message for AI/ML model inference to the E2 node(s). The data for AI/ML model inference may have the same form as that of the data used for AI/ML model training. Since the format of this data has been described in section (1) of FIG. 8A and FIG. 8B, redundant descriptions are omitted. In step S1121, the E2 node(s) may receive the data collection request message for AI/ML model inference from the SMO through the O1 interfaces.

In FIG. 11B, a case is assumed where the non-real time RIC provides the data collection request message for AI/ML model inference to the SMO. However, the SMO may independently determine whether data collection for AI/ML model inference is required and may transmit the data collection request message for AI/ML model inference to the E2 node(s).

In step S1122, the E2 node(s) may collect data in response to the data collection request message for AI/ML model inference and may transmit the collected data to the SMO through the O1 interface(s). To perform the operations of step S1122, the E2 node(s) may collect data for AI/ML model inference in advance before receiving the data collection request message for AI/ML model inference. When the E2 node(s) receive the data collection request message for AI/ML model inference, they may transmit the collected data to the SMO through the O1 interface(s). Accordingly, in step S1122, the SMO may receive the data collected by the E2 node(s) through the O1 interface(s).

In step S1123, the SMO may transmit a message requesting retrieval of collected data (i.e. data retrieval message) to the non-real time RIC. Accordingly, in S1123, the non-real time RIC may receive the data retrieval message from the SMO.

In step S1124, the non-real time RIC may perform AI/ML model inference based on the data retrieval message. Subsequently, in step S1125, the non-real time RIC may generate GoB beamforming configuration information. The GoB beamforming configuration information may be generated based on the AI/ML model inference.

In step S1126, the non-real time RIC may transmit a new GoB beamforming configuration application message to the E2 node(s). The new GoB beamforming configuration application message may be a message based on the GoB beamforming configuration information generated in step S1125. Since the non-real time RIC does not have a direct interface for transmitting information to the E2 nodes in S1126, the message may be transmitted via the SMO.

As in step S1120, the non-real time RIC may configure information related to beamforming to be performed by the E2 nodes or the O-RU based on inference using the AI/ML model trained in the AI/ML model training procedure.

Referring to FIG. 11C, the procedure S1130 may include the final operations in the AI/ML-based GoB beamforming optimization procedure and may correspond to the AI/ML model performance monitoring and update procedure.

The non-real time RIC may request data collection from the SMO when performance monitoring is required (not illustrated in FIG. 11C). Based on this request, the SMO may transmit a data collection request message for AI/ML model performance monitoring to the E2 node(s). The data used for AI/ML model performance evaluation may have the same form as that of the data used for AI/ML model training. Since the format of this data has been described in the section (1) of FIG. 8A and FIG. 8B, redundant descriptions are omitted. In step S1131, the E2 node(s) may receive the data collection request message for AI/ML model performance evaluation from the SMO through the O1 interfaces.

In FIG. 11C, a case is assumed where the non-real time RIC provides the data collection request message for AI/ML model performance evaluation to the SMO. However, the SMO may independently determine whether data collection for AI/ML model performance evaluation is required and may transmit the data collection request message for AI/ML model inference to the E2 node(s).

In S1132, the E2 nodes may collect data in response to the data collection request message for AI/ML model performance evaluation and may transmit the collected data to the SMO through the O1 interface. To perform the operations of step S1132, the E2 node(s) may collect data for AI/ML model performance evaluation in advance before receiving the data collection request message for AI/ML model performance evaluation. In other words, the E2 node(s) may collect data for AI/ML model performance evaluation in advance and, upon receiving the data collection request message for AI/ML model performance evaluation, may transmit the collected data to the SMO through the O1 interface. Accordingly, in step S1132, the SMO may receive the data collected by the E2 node(s) through the O1 interface(s).

In step S1133, the SMO may transmit a message requesting retrieval of collected data (i.e. data retrieval message) to the non-real time RIC. Accordingly, in step S1133, the non-real time RIC may receive the data retrieval message from the SMO.

In step S1134, the non-real time RIC may evaluate the AI/ML model's performance based on the data retrieval message. The performance evaluation may be a result of monitoring.

In step S1135, the non-real time RIC may retrain the AI/ML model based on the performance evaluation result and may update the AI/ML model based on the retraining. The update information in step S1135 may correspond to control information or policy information that enables the corresponding results to be derived through the inference results of the AI/ML model trained in the non-real time RIC. The update information generated in step S1135 may be transmitted to the E2 nodes via the SMO (not illustrated in FIG. 11C).

In step S1130, performance monitoring may correspond to observing the network performance resulting from beamforming configuration based on the inference results of the currently operating AI/ML model. Through this process, the non-real time RIC may determine whether the current AI/ML model remains valid. Additionally, the non-real time RIC may determine whether retraining and updating of the AI/ML model are required based on performance monitoring. The data collected in step S1130 may include KPI-related data for performance monitoring as well as data required for AI/ML model retraining and updates. To enable the transmission and reception of KPI-related data for performance monitoring between the E2 nodes and the SMO, the specifications of O1 interfaces may need to be updated to accommodate transmission and reception of the KPI-related data for performance monitoring.

### Beam Selection Optimization

After GoB beamforming optimization is performed by the non-real time RIC and the optimized GoB beamforming configuration is completed for the E2 nodes, such as the O-DU and/or O-RU, the beam selection optimization procedure may be performed based on a time slot to be provided by the O-RU to the UE.

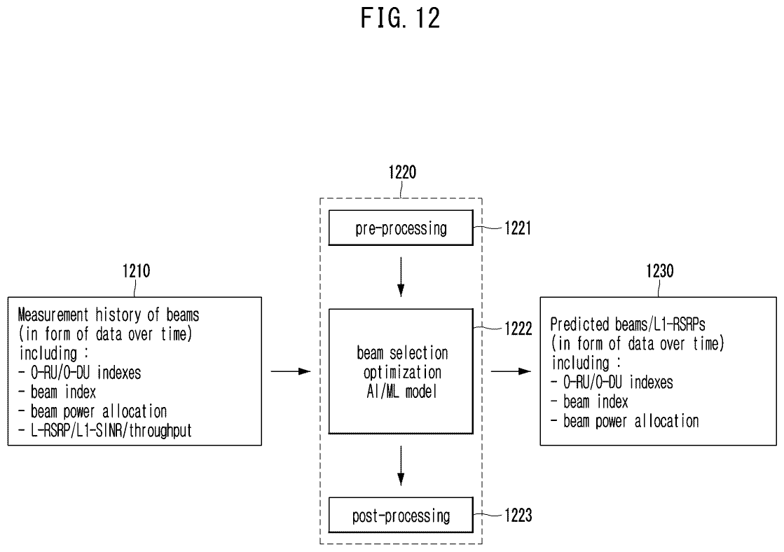

FIG. 12 is a conceptual diagram illustrating AI/ML operations for beam selection optimization in a near-real time RIC.

Referring to FIG. 12, input information 1210 for beam selection optimization may be applied to the AI/ML model for beam selection optimization in the near-real time RIC, thereby generating optimization information 1220, and the results may become output information 1230.

The input information 1210 for beam selection optimization may correspond to beam-related measurement information and may include at least one of the following.
1) O-RU index, O-DU index
2) Beam index
3) Beam power or beam power allocation information
4) L1-RSRP, L1-SINR, throughput

When the near-real time RIC receives the input information 1210, the near-real time RIC may generate inputs for the AI/ML model through a pre-processing block 1221. Therefore, the pre-processing block 1221 may perform an operation that transforms or extracts actual inputs for the AI/ML model from the input information 1210.

The beam selection optimization AI/ML model 1222 may be trained and/or used for inference, based on the pre-processed input information from the pre-processing block 1221. The beam selection optimization AI/ML model 1222 may output information based on the training and/or inference to the post-processing block 1223.

The post-processing block 1223 may generate and output beam selection optimization output information 1230 by processing the training and/or inference results of the AI/ML model.

The beam selection optimization output information 1230, which is the output of the AI/ML model, may correspond to information related to a beam to be directed to the RAN and may include at least one of the following.
1) Indexes of the O-RU/O-DU that is to use the designated beam
2) Beam index
3) Beam power

The output information 1230 of the AI/ML model may be delivered to the E2 node(s), such as the O-DU(s), through E2 control/policy messages from the near-real time RIC. The O-DU may select a beam and communicate with the UE based on the received output information 1230 from the near-real time RIC. In this case, the O-DU may allocate beam power for the selected beam based on the output information 1230.

Beam selection optimization may determine a beam to be used at a specific time based on beam-related measurement information collected at a specific time. Additionally, beam selection optimization may be performed based on temporal beam prediction, which predicts a beam to be used in a future time slot based on beam-related measurement information from past time periods. Therefore, it may be required to select and design an AI/ML model appropriate for the intended purpose.

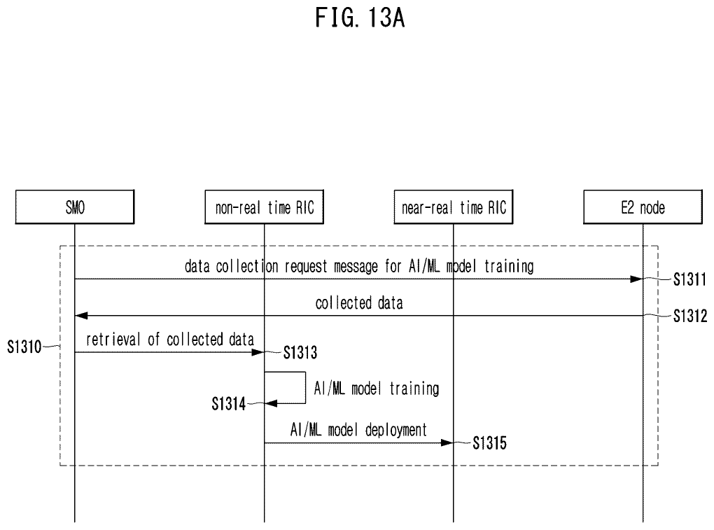

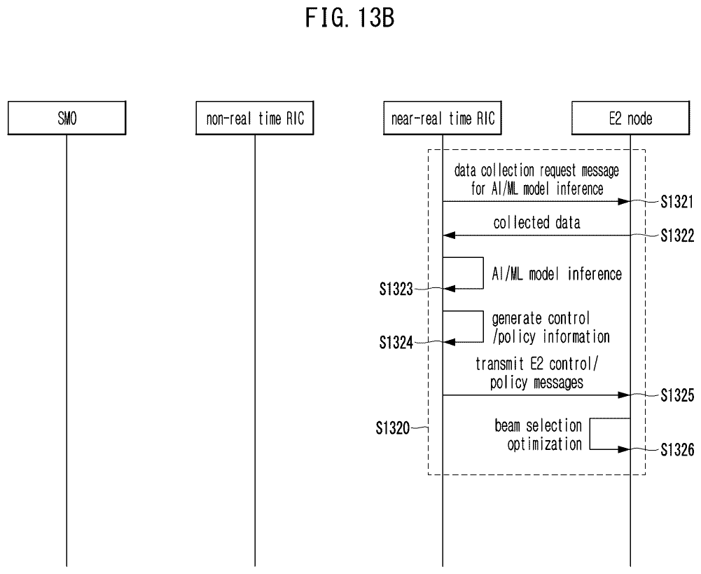

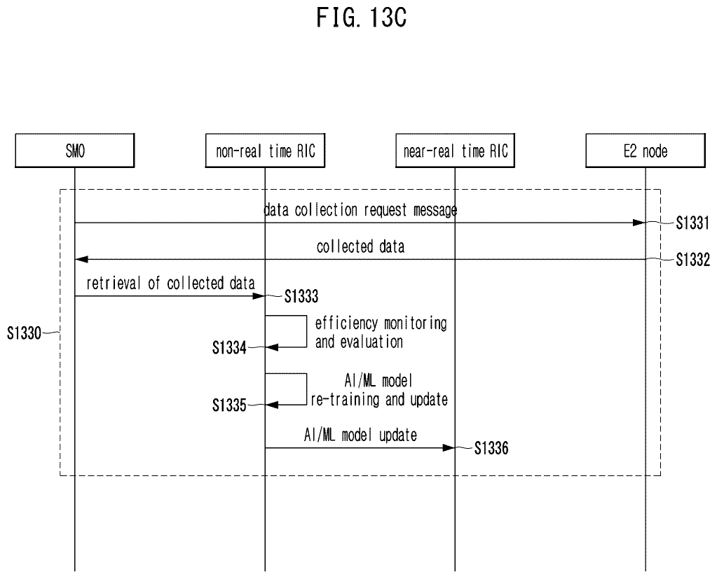

FIG. 13A is a sequence chart illustrating a training procedure in an AI/ML-based beam selection optimization procedure, FIG. 13B is a sequence chart illustrating an inference and beam selection optimization procedure in the AI/ML-based beam selection optimization procedure, and FIG. 13C is a sequence chart illustrating an efficiency monitoring and AI/ML model update procedure in the AI/ML-based beam selection optimization procedure.

The procedures in FIGS. 13A to 13C may be performed sequentially. For example, the training procedure S1310 in FIG. 13A may be performed first, followed by the inference and GoB beamforming optimization procedure S1320 in FIG. 13B, and finally, the efficiency monitoring and AI/ML model update procedure S1330 in FIG. 13C.

In another example, the procedures in FIGS. 13A to 13C may be performed independently of each other. In yet another example, the procedures in FIGS. 13A to 13C may be performed sequentially, but at least one of the procedures—S1310, S1320, or S1330—may be performed multiple times consecutively. In yet another example, the procedures in FIGS. 13A to 13C may be performed sequentially, but an additional procedure not illustrated in FIGS. 13A to 13C may be performed between any two procedures, such as between S1310 and S1320 or between S1320 and S1330.

The procedure S1310 may correspond to a procedure of selecting and training an AI/ML model for beam selection optimization during the initial deployment of the system or at long-term intervals. The procedure S1310 may require significant computational resources and may take a long time to complete. Therefore, in O-RAN, AI/ML model training is typically performed in the non-real time RIC, considering control latency.

Referring to FIG. 13A, the non-real time RIC may provide a data collection request message for AI/ML model training to the SMO (not illustrated in FIG. 13A). Accordingly, in step S1311, the SMO may transmit the data collection request message to the E2 node(s). Therefore, in step S1311, the E2 node(s) may receive the data collection request message for AI/ML model training from the SMO. In FIG. 13A, a case is assumed where the non-real time RIC provides the data collection request message for AI/ML model training to the SMO. However, the SMO may independently determine whether data collection for AI/ML model training is required and may transmit the data collection request message for AI/ML model training to the E2 node(s).

In step S1312, the E2 node(s) may collect data in response to the data collection request message for AI/ML model training and may transmit the collected data to the SMO. Accordingly, the SMO may receive the collected data.

In steps S1311 and S1312, message exchanges between the SMO and the E2 nodes may occur through the O1 interface(s). Additionally, the collected data for AI/ML model training may include previously described data such as CSI measurement information. To enable the transmission of such collected data to the SMO, the O1 interface may need to be standardized for this purpose.

In step S1313, the SMO may provide a message requesting retrieval of collected data (i.e. data retrieval message) to the non-real time RIC. Accordingly, in step S1313, the non-real time RIC may receive the data retrieval message from the SMO.

In step S1314, the non-real time RIC may train the AI/ML model based on the collected data. In this case, the AI/ML model may be selected or generated for beam selection optimization.

In step S1315, the non-real time RIC may deploy the AI/ML model to the near-real time RIC. The deployed AI/ML model may be the AI/ML model trained in step S1314.

Referring to FIG. 13B, the procedure S1320 may correspond to an inference and beam selection optimization procedure of the AI/ML model. The procedure S1320 may correspond to a procedure for AI/ML model inference and beam selection optimization using the AI/ML model generated or selected through training in the procedure S1310.

Information related to beam selection to be performed at the E2 nodes (primarily the O-DU) may be configured through inference using the AI/ML model trained in the AI/ML model training process. Since beam selection optimization requires fast control latency, it may be appropriate to perform the procedure in the near-real time RIC. Therefore, the present disclosure assumes a case where the near-real time RIC performs the beam selection optimization procedure.

In step S1321, the near-real time RIC may transmit a data collection request message for AI/ML model inference to the E2 nodes. Accordingly, in step S1321, the E2 node(s) may receive the data collection request message for AI/ML model inference from the near-real time RIC.

In step S1322, the E2 node(s) may collect data in response to the data collection request message for AI/ML model inference and may transmit the collected data to the near-real time RIC. To perform the operations of step S1322, the E2 node(s) may collect data for AI/ML model inference in advance before receiving the data collection request message for AI/ML model inference. In other words, before receiving the data collection request message for AI/ML model inference, the E2 node(s) may collect data for AI/ML model inference in advance. When the E2 nodes receive the data collection request message for AI/ML model inference, they may transmit the collected data to the near-real time RIC. Accordingly, in step S1322, the near-real time RIC may receive the data collected by the E2 nodes. In this case, data transmission between the near-real time RIC and the E2 nodes may be performed through the E2 interfaces. Additionally, the data for AI/ML model inference may have the same form as that of the data used for AI/ML model training.

In step S1323, the near-real time RIC may perform inference using the AI/ML model based on the collected data. A time of AI/ML model inference may correspond to a time when beam selection-related indication needs to be provided to the RAN. In other words, AI/ML model inference may be performed based on the beam-related information measured and collected before the time when beam selection-related indication needs to be provided to the RAN.

In step S1324, the near-real time RIC may generate E2 control and policy information. The E2 control and policy information may be obtained as a result of AI/ML model inference and may correspond to information for optimized beam selection.

In step S1325, the near-real time RIC may transmit the E2 control and policy message generated in step S1324 to the E2 node(s) through the E2 interfaces. Accordingly, in step S1325, the E2 node(s) may receive the E2 control and policy messages from the near-real time RIC.

In step S1326, the E2 node(s) may perform beam selection and optimization based on the E2 control and policy messages received in step S1325.

Referring to FIG. 13C, the procedure S1130 may correspond to the final operations in the AI/ML-based beam selection optimization procedure and may correspond to the performance monitoring and AI/ML model update procedure. Performance monitoring may correspond to a procedure for observing the network performance obtained as a result of beam selection based on the inference results of the currently operating AI/ML model. The performance monitoring may be used to verify whether the current AI/ML model remains valid.

The non-real time RIC may request data collection from the SMO when performance monitoring is required (not illustrated in FIG. 13C).

In step S1331, the SMO may transmit a data collection request message for AI/ML model performance monitoring to the E2 node(s). The data for AI/ML model performance evaluation may have the same form as that of the data used for AI/ML model training. In step S1331, the E2 node(s) may receive the data collection request message for AI/ML model performance evaluation from the SMO through the O1 interface.

In FIG. 13C, a case is assumed where the non-real time RIC provides the data collection request message for AI/ML model performance evaluation to the SMO. However, the SMO may independently determine whether data collection for AI/ML model performance evaluation is required and may transmit the data collection request message for AI/ML model inference to the E2 node(s).

In step S1332, the E2 node(s) may collect data in response to the data collection request message for AI/ML model performance evaluation and may transmit the collected data to the SMO through the O1 interface. To perform step S1332, the E2 node(s) may collect data for AI/ML model performance evaluation in advance before the required evaluation time. In other words, the E2 nodes may collect data for AI/ML model performance evaluation in advance before receiving the data collection request message for AI/ML model performance evaluation. When the E2 node(s) receive the data collection request message for AI/ML model performance evaluation, they may transmit the collected data to the SMO through the O1 interfaces. Accordingly, in step S1332, the SMO may receive the data collected from the E2 node(s) through the O1 interface(s).

The collected data in step S1332 may include KPI-related data for performance monitoring, data required for AI/ML model retraining, and data required for updates. To support transmission of the KPI-related data for performance monitoring in step S1332, the O1 interface may require standardization for the transmission of the following information.

First, beam prediction accuracy-related KPIs, such as Top-K/1 beam prediction accuracy.

Second, link quality-related KPIs, such as throughput, L1-RSRP, L1-SINR, and hypothetical block error ratio (BLER).

In step S1333, the SMO may transmit a message requesting retrieval of collected data (i.e. data retrieval message) to the non-real time RIC. Accordingly, in step S1333, the non-real time RIC may receive the data retrieval message from the SMO.

In step S1334, the non-real time RIC may evaluate the performance of the AI/ML model based on the data retrieval message. The performance evaluation may correspond to a result of monitoring.

In step S1335, the non-real time RIC may perform retraining of the AI/ML model based on the performance evaluation result and may update the AI/ML model based on the retraining.

In step S1336, the non-real time RIC may transmit the retrained and updated AI/ML model to the near-real time RIC.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a service management and orchestration framework (SMO), comprising:
transmitting, to an E2 node, a data collection request message for training an artificial intelligence (AI)/machine learning (ML) model;
receiving, from the E2 node, first data collected for training the AI/ML model; and
providing the collected first data to a non-real time radio access network (RAN) intelligent controller (RIC) to train the AI/ML model,
wherein the AI/ML model is an AI/ML model for Grid-of-Beams (GoB) beamforming or an AI/ML model for beam selection.

2. The method according to claim 1, wherein the data collection request message and the first data are transmitted through an O1 interface.

3. The method according to claim 1, wherein the first data includes at least one of: a user equipment (UE)-specific channel state information (CSI) report, UE-specific statistical CSI, UE-specific layer 1-received signal received power (L1-RSRP) measurement information, UE-specific CSI reference signal (CSI-RS) resource indicator (CRI) and synchronization signal (SS)/physical broadcast channel (PBCH) block resource indicator (RI), a UE-specific average downlink throughput at a base station (gNB), wideband channel quality indicator (CQI) distribution information, physical downlink shared channel (PDSCH) modulation and coding scheme (MCS) distribution information, or a beam prediction accuracy-related key performance indicator (KPI).

4. The method according to claim 1, further comprising:
transmitting, to the E2 node, a data collection request message for inference using the AI/ML model;
receiving, from the E2 node, second data collected for inference using the AI/ML model;
transmitting the second data to the non-real time RIC so that the non-real time RIC performs inference using the AI/ML model and generates configuration information of the AI/ML model; and
providing the configuration information of the AI/ML model to the E2 node.

5. The method according to claim 4, wherein the second data maintains consistency in type and structure with the first data.

6. The method according to claim 4, further comprising:
transmitting, to the E2 node, a data collection request message for performance evaluation of the AI/ML model;
receiving, from the E2 node, third data collected for performance evaluation of the AI/ML model; and
transmitting the third data to the non-real time RIC so that the non-real time RIC performs efficiency monitoring and evaluation of the AI/ML model.

7. The method according to claim 6, further comprising: in response to receipt of update information of the AI/ML model from the non-real time RIC, transmitting the update information of the AI/ML model to the E2 node.

8. The method according to claim 6, wherein the third data maintains consistency in type and structure with the first data.

9. The method according to claim 1, wherein the E2 node includes at least one of a central unit (O-CU) of an open RAN (O-RAN), or a distributed unit (O-DU) of the O-RAN.

10. A method of a non-real time radio access network (RAN) intelligent controller (RIC), comprising:
receiving, from a service management and orchestration framework (SMO), first data collected for training an artificial intelligence (AI)/machine learning (ML) model, the first data being collected from E2 nodes;
training the AI/ML model based on the first data; and
transmitting the trained AI/ML model to the E2 nodes via the SMO,
wherein the AI/ML model is an AI/ML model for Grid-of-Beams (GoB) beamforming or an AI/ML model for beam selection.

11. The method according to claim 10, wherein the first data includes at least one of: a user equipment (UE)-specific channel state information (CSI) report, UE-specific statistical CSI, UE-specific layer 1-received signal received power (L1-RSRP) measurement information, UE-specific CSI reference signal (CSI-RS) resource indicator (CRI) and synchronization signal (SS)/physical broadcast channel (PBCH) block resource indicator (RI), a UE-specific average downlink throughput at a base station (gNB), wideband channel quality indicator (CQI) distribution information, physical downlink shared channel (PDSCH) modulation and coding scheme (MCS) distribution information, or a beam prediction accuracy-related key performance indicator (KPI).

12. The method according to claim 10, further comprising:
receiving second data for inference of the AI/ML model from E2 node(s) via the SMO;
performing inference using the AI/ML model based on the second data;
generating configuration information of the AI/ML model based on the inference of the AI/ML model; and
providing the configuration information of the AI/ML model to the E2 node(s).

13. The method according to claim 12, further comprising:
receiving third data for performance evaluation of the AI/ML model from E2 node(s) via the SMO;
monitoring efficiency of the AI/ML model based on the third data; and
generating evaluation information of the AI/ML model based on a result of the monitoring of the efficiency of the AI/ML model.

14. A service management and orchestration framework (SMO) comprising at least one processor, wherein the at least one processor causes the SMO to perform:
transmitting, to an E2 node, a data collection request message for training an artificial intelligence (AI)/machine learning (ML) model;
receiving, from the E2 node, first data collected for training the AI/ML model; and
providing the collected first data to a non-real time radio access network (RAN) intelligent controller (RIC) to train the AI/ML model,
wherein the AI/ML model is an AI/ML model for Grid-of-Beams (GoB) beamforming or an AI/ML model for beam selection.

15. The SMO according to claim 14, wherein the data collection request message and the first data are transmitted through an O1 interface.

16. The SMO according to claim 14, wherein the first data includes at least one of: a user equipment (UE)-specific channel state information (CSI) report, UE-specific statistical CSI, UE-specific layer 1-received signal received power (L1-RSRP) measurement information, UE-specific CSI reference signal (CSI-RS) resource indicator (CRI) and synchronization signal (SS)/physical broadcast channel (PBCH) block resource indicator (RI), a UE-specific average downlink throughput at a base station (gNB), wideband channel quality indicator (CQI) distribution information, physical downlink shared channel (PDSCH) modulation and coding scheme (MCS) distribution information, or a beam prediction accuracy-related key performance indicator (KPI).

17. The SMO according to claim 14, wherein the at least one processor further causes the SMO to perform:
transmitting, to the E2 node, a data collection request message for inference using the AI/ML model;
receiving, from the E2 node, second data collected for inference using the AI/ML model;
transmitting the second data to the non-real time RIC so that the non-real time RIC performs inference using the AI/ML model and generates configuration information of the AI/ML model; and
providing the configuration information of the AI/ML model to the E2 node.

18. The SMO according to claim 17, wherein the second data maintains consistency in type and structure with the first data.

19. The SMO according to claim 17, wherein the at least one processor further causes the SMO to perform:
transmitting, to the E2 node, a data collection request message for performance evaluation of the AI/ML model;
receiving, from the E2 node, third data collected for performance evaluation of the AI/ML model; and
transmitting the third data to the non-real time RIC so that the non-real time RIC performs efficiency monitoring and evaluation of the AI/ML model.

20. The SMO according to claim 19, wherein the at least one processor further causes the SMO to perform: in response to receipt of update information of the AI/ML model from the non-real time RIC, transmitting the update information of the AI/ML model to the E2 node.
